(19) United States
(12) Patent Application Publication
(10) Pub. No.: US 2026/0310628 A1
(43) Pub. Date: Oct. 8, 2026

(54) PROCESSOR-IN-MEMORY (PIM) COMMAND TRUTH TABLE DEFINITION

(71) Applicant: QUALCOMM Incorporated, San Diego, CA (US)

(72) Inventors: Rui Cao, San Diego, CA (US); Subbarao Palacharla, San Diego, CA (US); Jungwon Suh, San Diego, CA (US); Wonhyung Song, San Diego, CA (US); Pankaj Deshmukh, San Diego, CA (US); Pan Deng, San Diego, CA (US); Mohammed Adnan Kazi, San Diego, CA (US)

(21) Appl. No.: 19/329,400

(22) Filed: Sep. 15, 2025

Related U.S. Application Data
(60) Provisional application No. 63/785,331, filed on Apr. 8, 2025.

(51) Int. Cl. G06F 15/78; G06F 1/12; G06F 9/30

(52) U.S. Cl. CPC G06F 15/7821; G06F 1/12; G06F 9/3004

(57) ABSTRACT

Example systems, methods, and apparatuses are disclosed for mapping, defining, and implementing processing-in-memory (PIM) operations using a command table for memory commands. An example method includes: identifying, by a memory controller, a memory command in the command table associated with the memory device; mapping, based on a set of command table IDs, the memory command to a PIM operation of a plurality of PIM operations; encoding the PIM operation into the command table; and executing, by the memory controller, the PIM operation using the command table.

### CROSS-REFERENCE TO RELATED APPLICATIONS

This application claims the benefit of U.S. Provisional Application No. 63/785,331, entitled, “PROCESSOR-IN-MEMORY (PIM) COMMAND TRUTH TABLE DEFINITION,” filed on Apr. 8, 2025, which is expressly incorporated by reference herein in its entirety.

### TECHNICAL FIELD

This disclosure relates generally to processing-in-memory architectures, and more specifically, to techniques for mapping commands in processing-in-memory devices and operations.

### BACKGROUND

Modern computing systems increasingly handle large-scale matrix computations, particularly in applications such as Large Language Models (LLMs). These computations often require significant memory bandwidth and computational resources. Processing-in-memory (PIM) architectures have emerged as a solution to address the memory bandwidth bottleneck by performing computations closer to where data resides. In PIM architectures, computational units are integrated within memory devices, such as Dynamic Random Access Memory (DRAM), to enable matrix-vector operations to be performed directly within the memory device. This approach can leverage higher memory bandwidth that is available inside the DRAM device compared to traditional architectures, i.e., where data must be transferred between memory and processor.

Among DRAM devices, Low-Power Double Data Rate (LPDDR) is a type of synchronous dynamic random-access memory (SDRAM) that consumes less power and is particularly suited for mobile computing devices such as laptop computers and smartphones. The Joint Electron Device Engineering Council (JEDEC) maintains and develops standards for boosting memory speed, increasing bandwidth, lowering power usage, and enhancing reliability, availability, and serviceability in LPDDR memory devices. In order to integrate DRAM devices such as LPDDR into a PIM architecture, various memory operations that are typically performed by such DRAM devices, including those specified in the latest JEDEC standards, may need to be mapped to new PIM operations. There is thus a desire and need for systems, methods, and techniques for mapping, enabling, and redefining DRAM commands into PIM operations to leverage benefits of PIM architectures in newer DRAM devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a processing-in-memory (PIM) device. The PIM device performs one or more first matrix-vector operations between a first portion of a weight matrix and an input vector, copies results of these operations to a register, initiates a read operation for the copied results from the register, and performs one or more second matrix-vector operations between a second portion of the weight matrix and the input vector in parallel with the read operation.

In some examples, the device defines, maps, and implements PIM operations and commands based on a command table. The command table may be used for executing memory commands, such as commands specified by JEDEC standards (e.g., LPDDR standards) for low power memory devices. However, disclosed herein are techniques for repurposing, utilizing the command table (e.g., data pins in the command table and identifying bits used for the memory commands) for the definition and implementation of PIM operations and PIM commands based on the PIM operations. In some embodiments, the PIM operations may include one or more PIM commands and may correspond to, build upon, combine, or otherwise expand existing memory commands (e.g., including those specified in LPDDR standards). For example, PIM operations may include the Write Register (WrReg) operation, the Read Register (RdReg) operation, the load and execute (LdExe) operation), and the move register (MovReg) operation. While the WrReg and RdReg operations may correspond to or may be mapped to memory commands of write short (WR-S) and read short (RD-S), respectively, the mapping and repurposing of the command table may involve using previously underutilized data pins to convey deeper information that the PIM operations provide that may not be covered in the corresponding memory commands. Furthermore, in some embodiments, PIM operations such as but not limited to LdExe and MovReg, may involve using memory commands typically reserved for future use (e.g., Reserved for Future Use (RFU) commands) and strategically using data pins to convey information for the PIM operation in a manner that conserves memory resources (e.g., column access bandwidth) and facilitates efficient interleaving and concurrent scheduling of operations.

In at least one embodiment, a memory controller of a PIM device identifies a memory command in a command table associated with the memory device (e.g., a low power memory device such as but not limited to LPDDR or other low power DRAM device). The command table may include one or more identifiable commands (e.g., based on a set of identifiable bits mapped to rises and falls of clock cycles) that a memory controller may use to execute. The memory controller may rely on a set of command table IDs to map the identified memory command to a PIM operation. For example, while the identified memory command may be a traditional memory command typically performed by the memory device, the PIM operation may be more extensive and deliver greater efficiency by allowing processing to occur within the memory device. In some aspects, the set of command table IDs may associate a command table (e.g., having a command table ID (CTID) of 0) to the currently identified memory command, and may associate other command tables (e.g., having CTIDs 1, 2, etc.) to one or more other commands such as those associated with the PIM operation. The memory controller may encode the PIM operation into the command table. For example, a new set of identifiable bits may be inputted into the command table (e.g., in one or more column addresses (CA)) that enable the PIM operation. The memory controller can then execute the PIM operation using the command table.

In one aspect of the disclosure, a method for implementing PIM operations using a command table associated with a memory device is disclosed. The method includes: identifying, by a memory controller, a memory command in the command table associated with the memory device; mapping, based on a set of command table IDs, the memory command to a PIM operation of a plurality of PIM operations; encode the PIM operation into the command table; and executing, by the memory controller, the PIM operation using the command table.

In an additional aspect of the disclosure, an apparatus for implementing PIM operations using a command table is disclosed. The apparatus includes: a memory including one or more registers and configured to store PIM contexts; and a memory controller coupled to the memory, and configured to perform operations, the operations including: identifying a memory command in the command table (e.g., DRAM command table) associated with the memory device; mapping, based on a set of command table IDs, the memory command to a PIM operation of a plurality of PIM operations; encode the PIM operation into the command table; and executing, by the memory controller, the PIM operation using the command table.

In an additional aspect of the disclosure, an apparatus for implementing PIM operations using a DRAM command table is disclosed. The apparatus includes: a memory including one or more registers and configured to store PIM contexts; and a memory controller coupled to the memory, and configured to perform operations, the operations including: identifying a memory command in the command table associated with the memory device; mapping, based on a set of command table IDs, the memory command to a PIM operation of a plurality of PIM operations; encode the PIM operation into the command table; and executing, by the memory controller, the PIM operation using the command table.

In an additional aspect of the disclosure, a system for implementing PIM operations using a DRAM command table is disclosed. The system includes: a plurality of command tables identifiable by a respective plurality of command table IDs, wherein the plurality of command tables includes at least a first command table comprising a memory command, and a second command table comprising a PIM command; a memory comprising one or more registers and configured to store PIM contexts; and a memory controller coupled to the memory, and configured to perform operations comprising: identifying the memory command in the first command table; mapping, based on a first command table ID identifying the first command table and a second command table ID identifying the second command table, the memory command to the PIM command; encoding the PIM command into the first command table; and executing, by the memory controller, the PIM command using the first command table.

These and other implementations may each optionally include one or more of the following features. For instance, various implementations may include one or more of: parallel processing capabilities, different memory configurations, various block sizes, different bit-width combinations, and different scaling factor arrangements.

The various aspects, implementations, and features disclosed herein may be implemented in a variety of ways. For example, aspects may be implemented as a device, such as a processing-in-memory device, a memory controller, or an integrated circuit. Aspects may also be implemented as one or more methods or processes. Further, aspects may be implemented as instructions stored in a computer-readable storage medium that, when executed by one or more processors, cause the processors to perform the disclosed operations. Such computer-readable storage media may include, but are not limited to, random access memory (RAM), read-only memory (ROM), electrically erasable programmable read-only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium capable of storing instructions for execution by processors.

The various aspects may also be implemented in hardware, software, firmware, or any combination thereof. For instance, aspects may be implemented as dedicated circuits or logic configured to execute the described functionality. Alternatively or additionally, aspects may be implemented as programs, modules, routines, or other software components executed by one or more processors. In some implementations, aspects may be implemented using application-specific integrated circuits (ASICs), field-programmable gate arrays (FPGAs), or other programmable logic devices.

The details of one or more implementations are set forth in the accompanying drawings and description below. Other features and advantages will be apparent from the description and drawings, and from the claims. It is to be understood that both the foregoing general description and the following detailed description are exemplary and explanatory only and are not restrictive of the invention, as claimed. Features shown in the various figures can be combined and/or modified in ways not explicitly shown, while remaining within the scope of the claims.

### DESCRIPTION OF THE FIGURES

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a processing-in-memory system that can be configured for performing efficient matrix computations and other PIM operations according to one or more aspects of this disclosure.

FIG. 2A shows a block diagram illustrating a basic PIM DRAM architecture that can support matrix-vector multiplication and other PIM operations according to one or more aspects of this disclosure.

FIG. 2B shows an operational flow diagram illustrating matrix-vector multiplication processes within the PIM DRAM architecture according to one or more aspects of this disclosure.

FIG. 3 shows a table of DRAM commands and identifying bits in a command table according to one or more aspects of this disclosure.

FIG. 4 shows block diagrams illustrating the mapping of DRAM commands into PIM operations using a command table decoder according to one or more aspects of this disclosure.

FIG. 5 shows a section of a DRAM command table where column addresses are repurposed to reference PIM command tables according to one or more aspects of this disclosure.

FIG. 6 shows clock cycle diagrams showing the switching between operations with and without command gaps according to one or more aspects of this disclosure.

FIG. 7 shows a clock cycle diagram showing the switching between PIM and non-PIM operations using the same column address according to one or more aspects of this disclosure.

FIG. 8 shows a table mapping PIM operation codes (opcodes) to DRAM commands according to one or more aspects of this disclosure.

FIG. 9 shows sections of a DRAM command table defining the PIM commands of write vector (WrVec) and read vector (RdVec) and the broadcast and reset functionalities based on a repurposing of DRAM pins according to one or more aspects of this disclosure.

FIG. 10 shows sections of a DRAM command table defining write accumulator and read accumulator PIM operations and the broadcast PIM function based on a repurposing of DRAM pins according to one or more aspects of this disclosure.

FIG. 11 shows sections of a DRAM command table defining the PIM operation of load and execute (LdExe) based on a repurposing of DRAM pins according to one or more aspects of this disclosure.

FIG. 12 shows sections of a DRAM command table defining the PIM operation of move register (MovReg) based on a repurposing of DRAM pins according to one or more aspects of this disclosure.

FIG. 13 shows a DRAM command table being reprogrammed for new PIM functions according to one or more aspects of this disclosure.

FIG. 14 shows sections of a DRAM command table defining the PIM operations for activate and precharge for single banks and multiple banks based on a repurposing of DRAM pins according to one or more aspects of this disclosure.

FIG. 15 shows a DRAM command table being used to extend register size for new PIM functions according to one or more aspects of this disclosure.

FIG. 16 shows a flow chart of an example method for implementing PIM operations using a DRAM command table according to one or more aspects of this disclosure.

FIG. 17 shows a block diagram of an example PIM device configured to implement PIM operations using a DRAM command table according to one or more aspects of this disclosure.

Like reference numbers and designations in the various drawings indicate like elements.

### DETAILED DESCRIPTION

The present disclosure provides systems, apparatus, methods, and computer-readable media that support improved processing-in-memory operations, such as techniques for mapping PIM operations to, and implementing PIM operations using, a DRAM command table.

Shortcomings of previous techniques mentioned here are only representative and are included to highlight problems that the inventors have identified with respect to existing processing-in-memory devices and sought to improve upon. Lower power memory devices, such as low power double data rate (LPDDR) synchronous DRAM (referred to herein as LPDDR for simplicity) are increasingly used for mobile computing devices. The Joint Electron Device Engineering Council (JEDEC) maintains and develops standards for boosting memory speed, increasing bandwidth, lowering power usage, and enhancing reliability, availability, and serviceability in low power memory devices such as LPDDR. In order to integrate low power DRAM devices such as LPDDR into a PIM architecture, various memory operations that are typically performed by such DRAM devices, including those specified in the latest JEDEC standards (e.g., LPDDR standards), would need to be mapped to new PIM operations. There is thus a desire and need for systems, methods, and techniques for mapping, enabling, and redefining DRAM commands into PIM operations to leverage benefits of PIM architectures in LPDDR and other low power memory devices. In particular, there is a desire and need for mapping and implementing new PIM commands to command tables for the low power memory devices specified in the latest JEDEC standards (e.g., LPDDR standards) in order to support higher efficiency PIM operations and minimize latency when switching between PIM and non-PIM transactions. Aspects of devices described below may address some or all of these needs as well as others known in the art. Aspects of the improved devices described herein may present other benefits than, and be used in other applications than, those described above.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, memory devices, and processes to provide a thorough understanding of the present disclosure. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a processing-in-memory device.

Aspects of this disclosure involve techniques for mapping PIM operations to, defining PIM operations based on a repurposing of existing data pins of, and implementing PIM operations using, a command table of a memory device. The techniques enable integration between and achieve the benefits of PIM architectures and low power memory devices such as LPDDR. In particular, the techniques enable PIM commands to be implemented on command tables for low power DRAM devices specified in the latest JEDEC standards (e.g., LPDDR standards) in order to support higher efficiency PIM operations and minimize latency when switching between PIM and non-PIM transactions.

Various embodiments of the present disclosure may involve a memory controller identifying a memory command in a command table associated with a memory device (e.g., a DRAM device). The command table may include one or more identifiable commands (e.g., based on a set of identifiable bits mapped to rises and falls of clock cycles) that a memory controller may use to execute. The memory controller may rely on a set of command table IDs to map the identified memory command to a PIM operation. For example, while the identified memory command may be a traditional memory command typically performed by the memory device, the PIM operation may be more extensive and deliver greater efficiency by allowing processing to occur within the memory device. In some aspects, the set of command table IDs may include a command table ID (CTID 0) associated with the currently identified memory command, and other command table IDs (CTIDs 1, 2, etc.) associated with one or more other commands such as PIM commands associated with the PIM operation. The memory controller may encode the PIM operation into the command table. For example, a new set of identifiable bits may be inputted into the command table (e.g., in one or more column addresses (CA)) that enable the PIM operation. The memory controller can then execute the PIM operation using the updated command table. In some embodiments, an update to a command table may result in a new command table.

The PIM operations that can be mapped to, defined based on a repurposing of data pins of, and implemented using the command table include the activation and precharging of multiple banks. By using activating and precharging multiple banks, the techniques support for the interleaving of operations using multiple banks sets, which thus optimizes efficiency.

As will be discussed herein, when consecutive operations are based on or share the same CTID, the consecutive operations may be executed on data stored in same set of column addresses, which thus facilitates faster switching between PIM and non-PIM transactions. The faster switching enables concurrent use cases (e.g., concurrent applications based on a shared set of hardware resources) and supports multiple contexts.

Various embodiments of the present disclosure involve repurposing column addresses of command table to encode PIM operations in a manner that minimizes the identifying bits, column addresses, and clock cycles. By minimizing such resources (e.g., 4nCK commands, CA-bandwidth, use of identifiable bits to encode a PIM command), the presently disclosed techniques optimize for scheduling flexibility.

Furthermore, PIM operations are defined using the resources of the DRAM command table in a manner that memory commands sharing the same or similar operation codes have common or similar column addresses or data pin (DQ) characteristics. Thus, the presently disclosed techniques allow for definition consistency, such as when translating DRAM commands to PIM commands using the command table.

Various embodiments of the present disclosure also describe the reprogramming of the DRAM command tables to support additional or new PIM operations (e.g., new PIM opcodes). Further, the present disclosure also provide techniques for allowing the command table to support a larger register file size. Such embodiments allow for scalability of the presently disclosed techniques to support the evolving nature of PIM architecture.

By performing operations (e.g., PIM and non-PIM) within the memory device itself, implementations can minimize data movement between memory and processing units. To that end, implementations described herein encompass processing-in-memory approaches that contribute to efficient processing. The processing-in-memory devices described herein can also implement sophisticated data management techniques to maintain efficient operation.

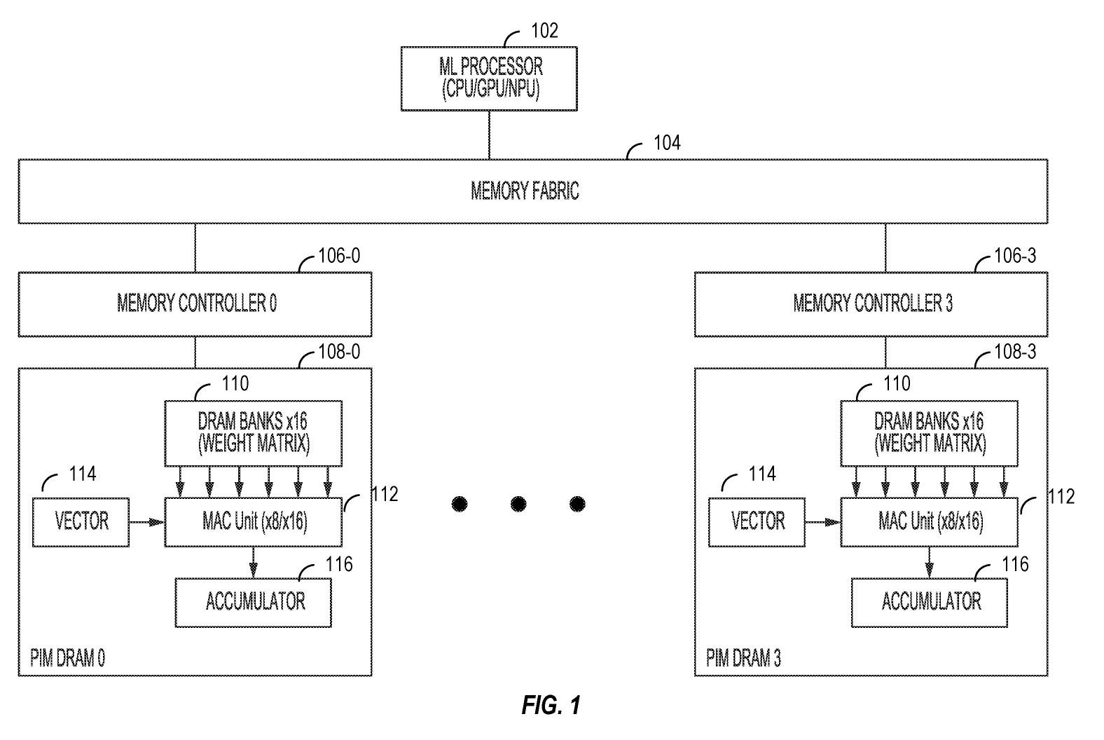

FIG. 1 illustrates a block diagram of a processing-in-memory system 100 that enables computation directly within memory devices (e.g., low power memory devices such as but not limited to LPDDR) according to aspects described herein. System 100 includes a machine learning (ML) processor 102, which may be implemented using various processing architectures. For example, processor 102 may comprise a central processing unit (CPU), graphics processing unit (GPU), neural processing unit (NPU), application-specific integrated circuit (ASIC), or combinations thereof. ML processor 102 can be configured to manage high-level operations, distribute computational tasks, and coordinate processing across memory devices.

A memory fabric 104 couples to ML processor 102 and enables data movement and processing capabilities. Memory fabric 104 can be specialized to support various processing-in-memory operations through command handling, routing protocols, and synchronization mechanisms. The fabric 104 may implement different interconnect technologies and topologies depending on system requirements, including point-to-point connections, crossbar switches, or mesh networks.

Memory fabric 104 connects to multiple memory controllers 106 (illustrated as controllers 106-0 through 106-3 in one implementation, though other quantities may be implemented). Each memory controller 106 can be configured to support processing-in-memory commands and operations beyond traditional memory access patterns. Controllers 106 may implement specialized command queues, reordering logic, and timing control to manage both conventional memory operations and processing-in-memory functions. For example, controllers 106 may manage conventional memory commands such as those typically performed by low power memory devices and those specified by JDEC standards (e.g., LPDDR standards). However, such controllers 106 may repurpose conventional memory commands (e.g., via command tables) to implement new PIM operations, as described in the present disclosure. Different implementations may employ varying numbers of controllers based on factors such as system size, bandwidth requirements, and power constraints.

Each memory controller 106 couples to a corresponding processing-in-memory DRAM (PIM DRAM) device 108. In some embodiments, the PIM DRAM device 108 may include or may comprise a low power memory device such as but not limited to LPDDR devices specified by JEDEC standards. While four PIM DRAM devices (108-0 through 108-3) are shown, systems may scale from single devices to large arrays of devices. Each PIM DRAM 108 includes multiple DRAM banks 110, which may be implemented in various configurations (for example, eight, sixteen, or thirty-two banks per device). The DRAM banks 110 can be configured to store different types of data, including weight matrices for neural network computations, activation values, or general computational data structures. DRAM Banks 110 may be organized into different zones or regions optimized for specific access patterns or computational requirements.

Within each PIM DRAM 108, multiply-accumulate (MAC) units 112 couple to DRAM banks 110 and can be configured to perform various computational operations, such as but not limited to multiplication and accumulation to more complex functions. In some embodiments, arithmetic logic units (ALUs) may be used in addition to or as an alternative to MAC units 112 to perform the computational operations. The number and capability of MAC units 112 may vary by implementation, with configurations ranging from four to thirty-two units being common examples. MAC units 112 can support multiple precision formats (for example, 4-bit, 8-bit, 16-bit operations) and various operational modes, including Single Instruction Multiple Data (SIMD) execution where a single command triggers parallel execution across all units within a device.

Vector interfaces 114 provide input paths for vector data into MAC units 112. These interfaces can support different data widths and formats, enabling flexible handling of input vectors. Vector accumulators 116 couple to MAC units 112 in each PIM DRAM 108 and can be configured with varying bit widths and accumulation depths based on application requirements.

The system supports sophisticated execution models across different hierarchical levels. Within each PIM DRAM 108, SIMD execution enables efficient parallel processing across MAC units. Across different PIM DRAM devices 108, Multiple Instruction Multiple Data (MIMD) execution allows independent operations to proceed in parallel, which are managed through software orchestration via spawn and synchronization mechanisms controlled by ML processor 102. Execution of various commands by the memory controller 106 may be performed by way of a command table as described in the present disclosure.

Memory controllers 106 implement complex coordination mechanisms to manage both traditional memory access as well as processing-in-memory operations. This can include specialized command scheduling, resource allocation, and synchronization across multiple devices. The architecture enables significant bandwidth improvements compared to traditional approaches by minimizing data movement between memory and processing units. In operation, system 100 can handle diverse computational workloads by distributing operations across multiple PIM DRAM devices 108. Data structures may be partitioned and distributed across DRAM banks 110 in various ways depending on application requirements. The architecture supports different scaling approaches, from small embedded systems to large computational arrays, while maintaining the benefit of performing computations close to data storage.

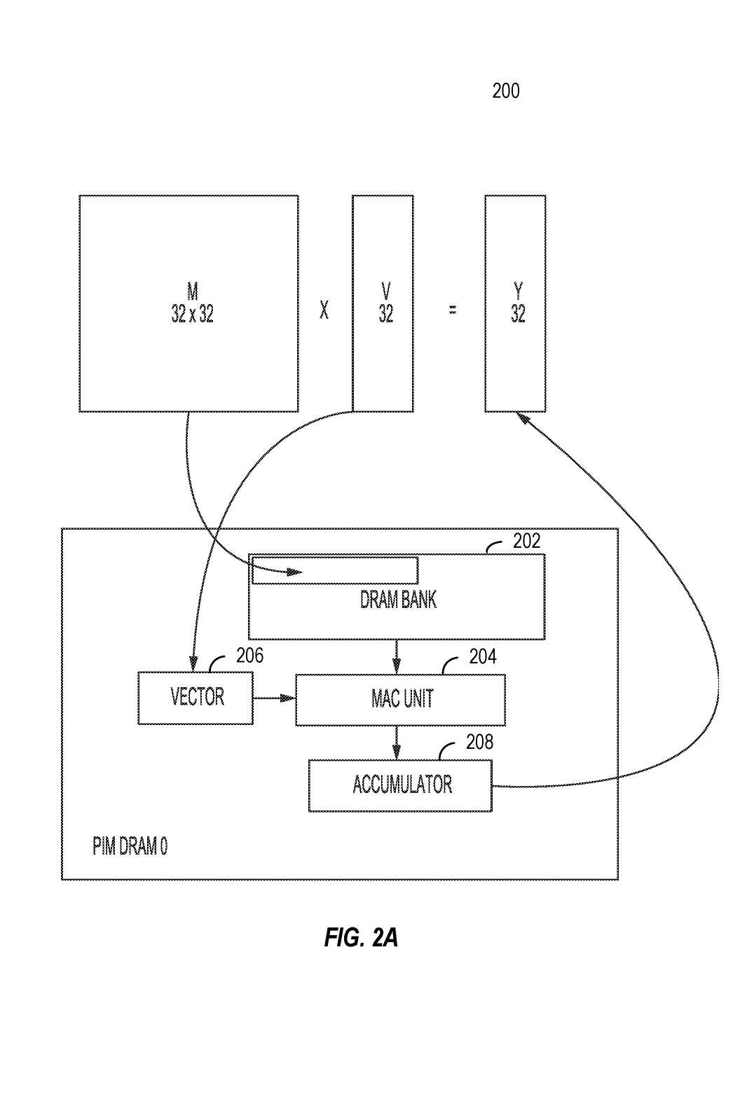

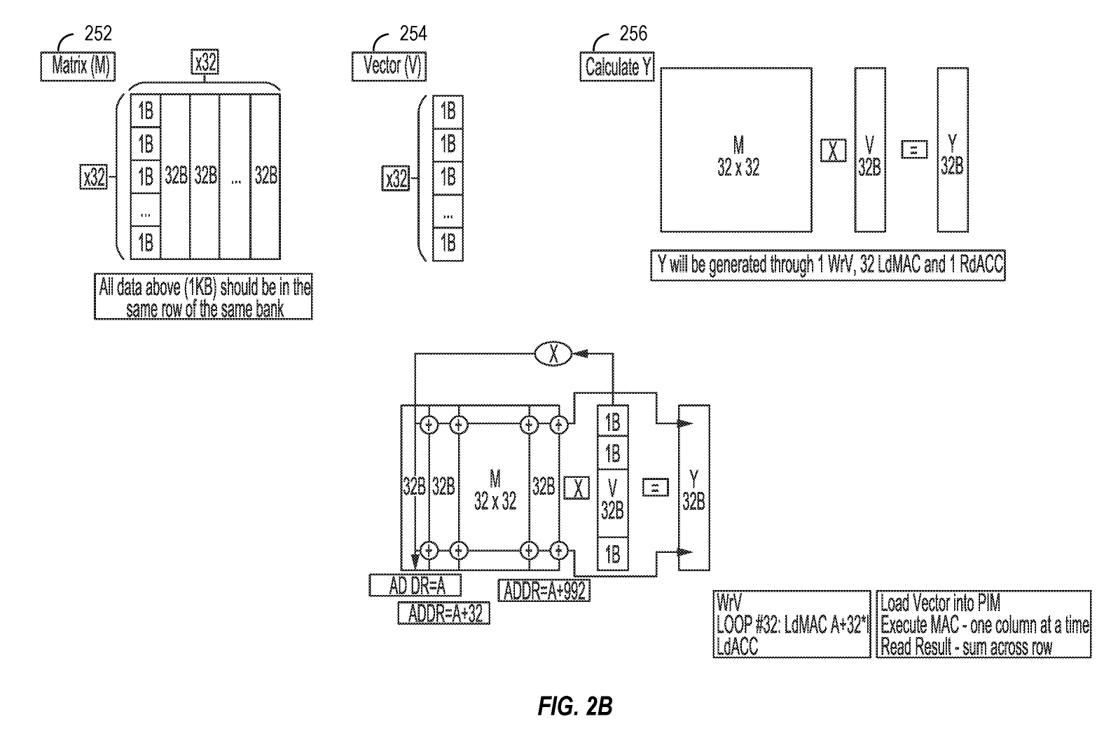

FIGS. 2A and 2B illustrate processing-in-memory operation fundamentals that can support efficient matrix computations, including PIM operations for neural network processing, according to aspects described herein. FIG. 2A shows a basic PIM DRAM architecture 200 while FIG. 2B illustrates the corresponding operational flow 250 of matrix-vector multiplication within the architecture.

Referring to FIG. 2A, a PIM DRAM architecture 200 can include a DRAM bank 202 configurable to store matrix data, such as neural network weight matrices. In mobile or resource-constrained systems, these weights may be stored in reduced precision formats, such as 4-bit values, to minimize memory footprint. A MAC unit 204 can couple to DRAM bank 202 and may process matrix values along with vector inputs. Vector register 206 can provide storage for input vectors and may couple to the MAC unit 204. An accumulator 208 can couple to the MAC unit 204 and may store operation results.

FIG. 2B details the operational flow 250 of matrix-vector multiplication within architecture 200. A weight matrix M 252 can be arranged as a 32 x 32 matrix occupying, for example, 1 kilobyte of memory in DRAM bank 202, though other sizes and arrangements may be implemented. An input vector V 254 may comprise 32 elements stored in vector register 206, with the size being configurable based on implementation requirements. The multiplication operation produces a result vector Y 256 that can be stored in accumulator 208.

The operational sequence can begin with a Write Vector (WrV) operation that loads input data into vector register 206. After activating the appropriate DRAM page, the system can perform a series of Load and MAC (LdMAC) operations, processing one matrix column at a time through MAC units 204. Results may accumulate in accumulator 208 and can be accessed through Load Accumulator (LdACC) operations.

The architectures of FIGS. 1, 2A, and 2B can enable the mapping to, defining and implementation of PIM operations using underlying DRAM execution frameworks. For example, the DRAM bank 202 can store data in a plurality of memory banks that are each organized in a plurality of column addresses (CAs) that may store bits. The memory controller 106 may also rely on a command table to execute memory commands on the DRAM banks 202. The command table may indicate bits in various column addresses that are used to signify or indicate conventional memory commands to be executed. A set of command table IDs may be used to redefine bits of the various column addresses of the command table as signifying PIM operations. The PIM operations may then be executed using the vector register 206, MAC unit 204, and/or the accumulator 208.

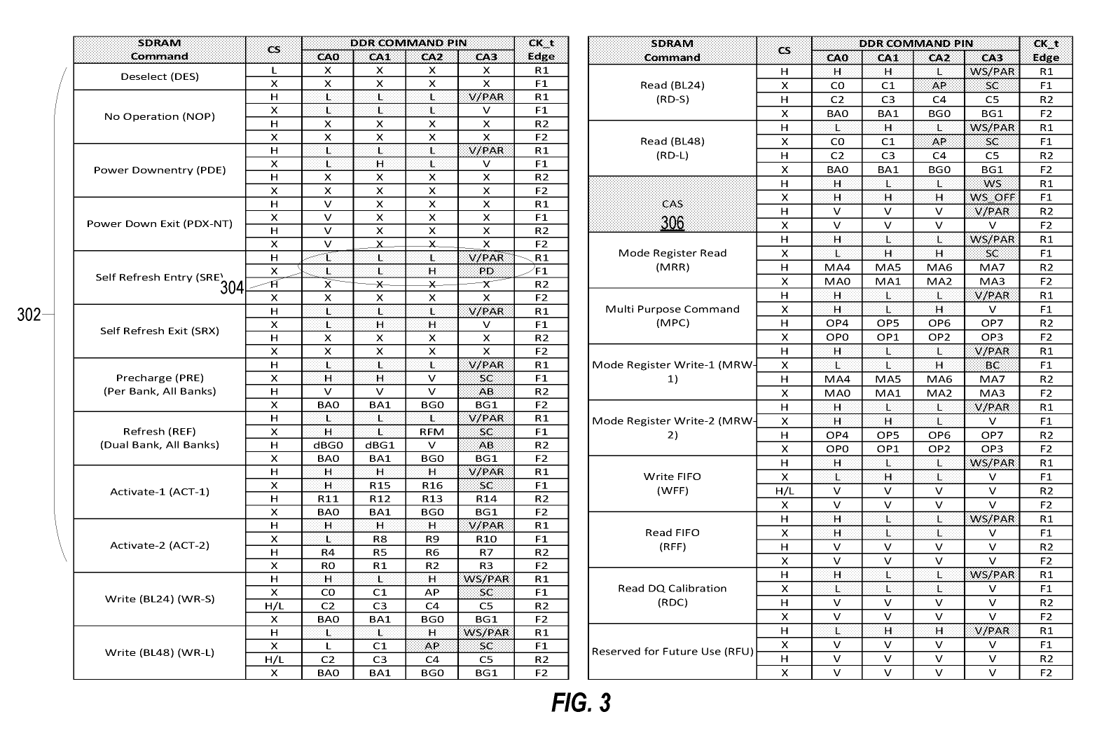

FIG. 3 shows a table of DRAM commands and identifying bits in a command table according to one or more aspects of this disclosure. As previously discussed, the DRAM banks 202 can be used to perform memory functions (e.g., DRAM commands) while also enabling the mapping to, defining, and implementation of PIM operations. With respect to the memory functions, according to JEDEC’s LPDDR standards, the memory controller of DRAM devices such as LPDDR may perform a plurality of DRAM commands as shown in FIG. 3. Although FIG. 3 and the corresponding description refers to DRAM commands, it is contemplated that other low power memory commands can also be mapped to and redefined to implement PIM operations using the techniques disclosed herein. In some aspects, the DRAM commands may be referred to herein as memory commands.

Each DRAM command may be performed by the memory controller based on a set of bits recognized by the memory controller that indicate the DRAM command to be performed. The set of bits may also be referred to herein as the set of “identifying bits” and is shown in FIG. 3 in light shade. The set of identifying bits of each operation may be organized in various column addresses (e.g., CA0, CA1, CA2, CA3) over one or two clock cycles (e.g., first rise (R1), first fall (F1), second rise (R2), second fall (F2)). For example, for the DRAM command of “Self Refresh Entry (SRE)”, the set of identifying bits 304 include a low signal, low signal, a high signal, and a variable and/or parity bit (V/PAR) during the first rising edge of the clock (R1) for the column addresses CA0, CA1, CA2, and CA3, respectively. During the first falling edge of the clock (F1), the set of identifying bits 304 further include a low signal, a low signal, a high signal, and a PD signal for the column addresses CA0, CA1, CA2, and CA3, respectively. The listing of such identifying bits for each operation in this manner to prompt the memory controller to execute such operation when detected may be referred to herein as a command table.

Although the commands listed in FIG. 3 are DRAM memory commands, the present disclosure describes techniques for repurposing or mapping such DRAM commands to perform new PIM operations by way of a set of command table IDs. For example, the memory controller may recognize the sets of identifying bits as corresponding to the DRAM commands shown in FIG. 3 based on determining a certain command table ID (CTID), such as a default CTID (e.g., CTID 0). However, the implementation of additional or alternative CTIDs (e.g., CTID 1, CTID 2, CTID 3, etc.) may be used to repurpose identifying bits or allow new sets of identifying bits for the execution of new PIM commands or operations.

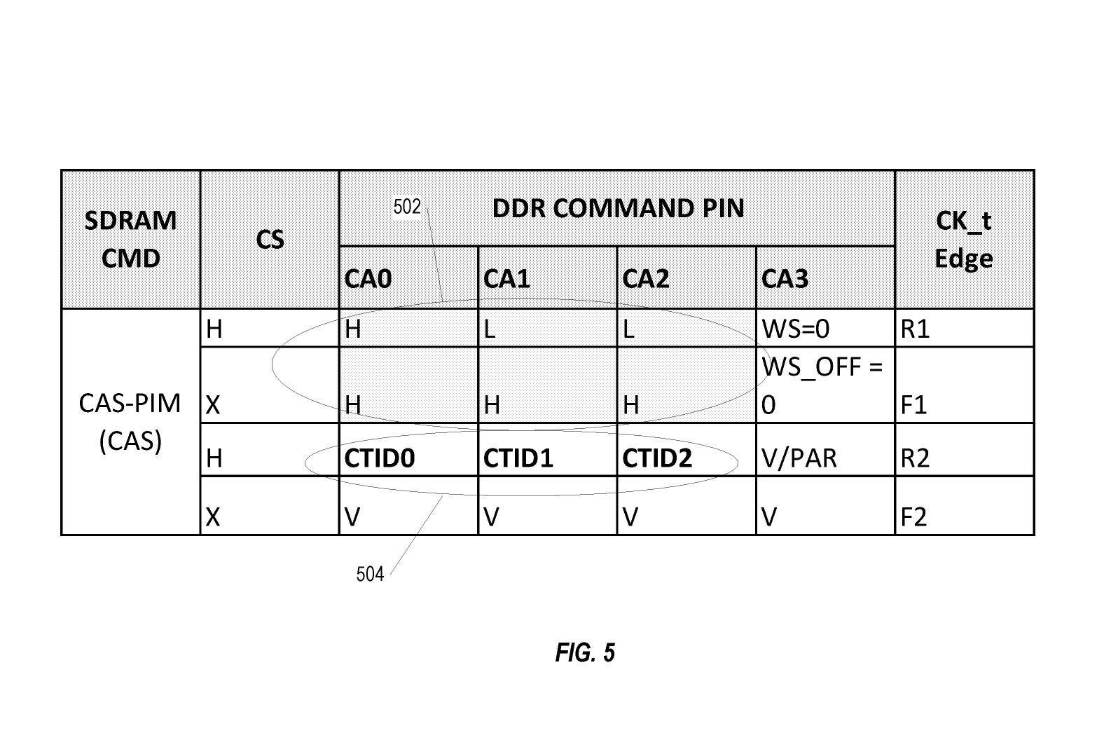

In various aspects, the memory controller may toggle or switch from one CTID to another CTID by performing the clock auto synchronization (CAS) operation (also referred to, in some aspects, as column address strobe operation). As shown in FIG. 3, the CAS operation 306 can be performed upon detection of the set of identifying bits that includes H, L, L, and WS for the column addresses CA0, CA1, CA2, and CA3, respectively, during the first rising clock edge (R1), and the identifying bits H, H, H, and WS_OFF for the column addresses CA0, CA1, CA2, and CA3, respectively, during the first falling clock edge (F1). As will be discussed herein (e.g., in relation to FIG. 5), a set of identifying bits for the next clock edge (R2) after the aforementioned identifying bits for the CAS operation may be used to identify the CTID for the memory controller to switch to for the purpose of repurposing the command table to perform PIM and other newer operations.

In some embodiments, some DRAM commands may be independent of CTID, as shown by group 302. Thus, in such embodiments, the memory controller may be able to perform such aforementioned DRAM commands irrespective of the CTID the command table is currently toggled to, as such operations may be more administrative in nature. Such DRAM commands of group 302 that are independent of the CTID may include: Deselect, No Operation (NOP), Power DownEntry (PDE), Power Down Exit (PDX-NT), Self Refresh entry (SRE), Self Refresh Exit (SRX), Precharge (PRE), Refresh (REF), Activate-1 (ACT-1), and Activate-2 (ACT-2). In contrast, DRAM commands that can be CTID dependent may include but are not limited to: Write (BL24) (Wr-S), Write (BL48)(WR-L), Read (BL24) (Rd-S), Read (BL48) (Rd-L), Mode Register Read (MRR), Multi Purpose Command (MPC), Mode Register Write-1 (MRW-1), Mode Register Write-2 (MRW-2), Write FIFO (WFF), Read FIFO (RFF), Read DQ Calibration (RDC), RFU.

PIM operations may include one or more PIM commands and may correspond to, build upon, combine, or otherwise expand existing DRAM memory commands shown in FIG. 3. For example, PIM operations may include the Write Register (WrReg) operation, the Read Register (RdReg) operation, the load and execute (LdExe) operation), and the move register (MovReg) operation.

The WrReg operation may be used for writing data (e.g., 32B, 64B, etc.) into PIM unit (PU) registers through data pins (DQ) and may include the PIM commands of Write Vector (WrVec) and Write Instruct (WrInst). The WrReg operation may be broadcasted to multiple banks, though bank activation may not be needed for the performance of the Wr Reg operation.

The RdReg operation may be used for reading data (e.g., 32B, 64B, etc.) from PU registers through data pings (DQ), and may include the PIM commands Read Accumulate (RdAcc). In some embodiments, memory bank activation may not be needed to perform the Rd Reg operation on the memory bank.

The LdExe operation for loading data (e.g., 32B, 64B, etc.) from memory banks, executing certain PIM commands (e.g., multiply and accumulate (MAC), multiple (MUL), load and scale (LdScale), etc.), and store results PU registers. The LdExe operation may be broadcasted to multiple memory banks. In some aspects, bank activation of the memory banks may be needed (e.g., via an Activation (ACT) function) for the performance of the LdExe operation on the memory banks.

The MovReg operation may be used for loading and storing data (e.g., 32B data, 64B data, etc.) between a PU register and a memory bank. The MovReg operation may allow for the broadcasting the operation to multiple PIM memory banks. In some aspects, the memory banks may need to be activated (e.g., via an ACT function) before MovReg operation can be performed using the memory bank. The MovReg operation may include the PIM commands of store and accumulate (StAcc) and load vector (LdVec).

As will be discussed herein, such PIM operations of WrReg, RdReg, LdExe, and MovReg may be performed by the memory controller by repurposing the command table of DRAM commands (shown in FIG. 3) by switching to a different CTID.

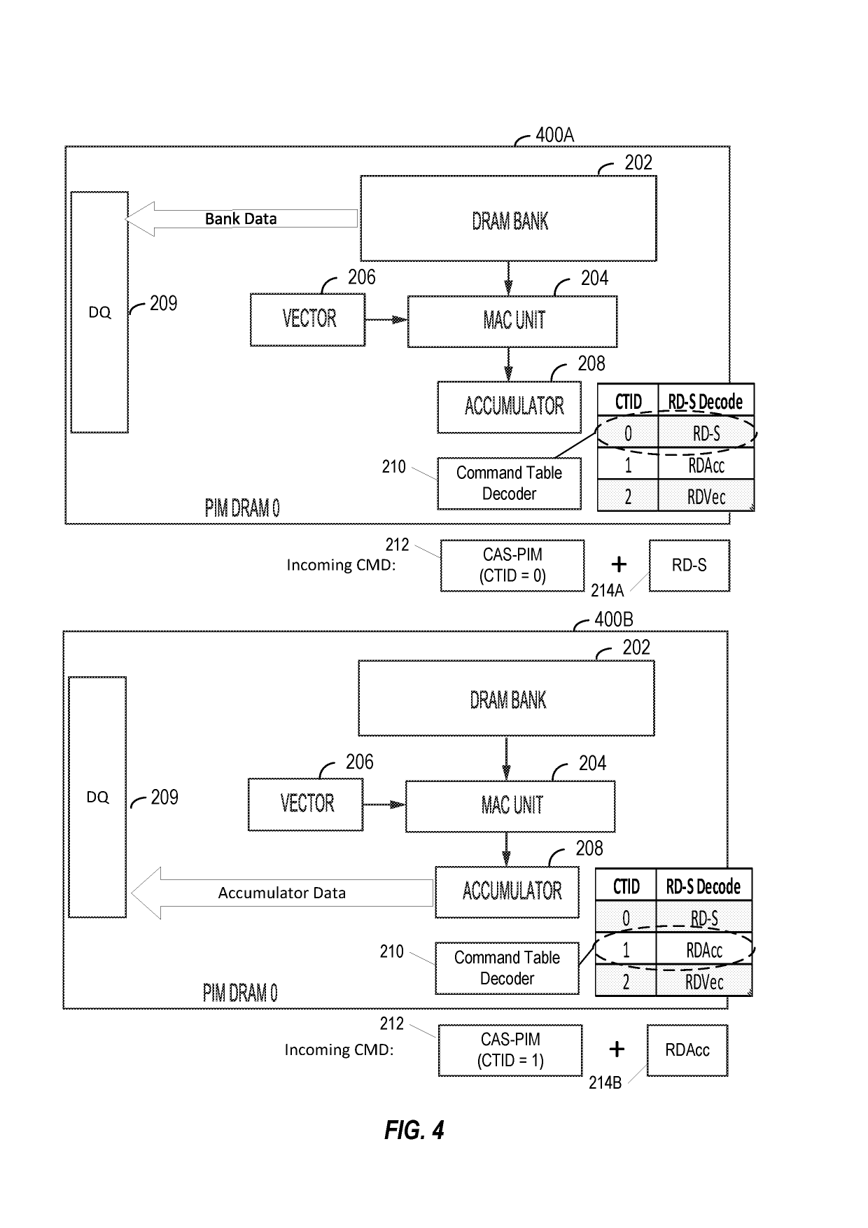

FIG. 4 shows block diagrams illustrating the mapping of DRAM commands into PIM operations using a command table decoder according to one or more aspects of this disclosure. For example, as previously described in relation to FIG. 2A, a DRAM bank 202 may store matrix data, while MAC unit 204 (and/or an ALU in some embodiments) coupled to the DRAM bank 202 and may process matrix values along with vector inputs. The vector register 206 can provide storage for input vectors and may couple to MAC unit 204. An accumulator 208 can couple to the MAC unit 204 and may store operation results. The DRAM may be configured to output data from different components and/or at different points of the operation depending on the CTID that the DRAM may be configured to.

As shown in configuration 400A, at CTID = 0, the memory controller is configured to execute the DRAM command, read short (RD-S), which is defined as reading a 32 byte data from the DRAM bank 202. Thus, as shown in configuration 400A, data from the DRAM bank 202 is output into data pins (DQ) 209 based on the DRAM command, RD-S. However, if the CTID were to be toggled to CTID=1 (e.g., via a CAS-PIM command 212), as shown in configuration 400B, the memory controller may be configured to execute the PIM command, RdAcc, which is defined as reading data from the accumulator register 208. Thus, as shown in configuration 400B, accumulator data is shown as being output from the accumulator register 208 onto the data pins (DQ) 209. Based on each CTID, the memory controller may decode the commands 214A-214B specified by the command table (e.g., determine the command specified by the set of identifying bits) using a command table decoder 210.

The memory controller may cause the DRAM command table configuration to switch (e.g., toggle) between different CTIDs using a repurposed CAS command. The repurposed CAS command, referred to herein as CAS-PIM command 212, may be one where addresses spaces in the next clock edge after the set of identifying bits are used to identify the CAS command are used to identify the specific CTID to toggle to. As the command table specified by each CTID may have different sets of identifying bits for different commands 214A-214B, the CAS-PIM command may allow the memory controller to switch between command tables specified for regular and PIM operations.

For example, while JEDEC’s LPPDR6 standard specifies a single command table for the execution of DRAM commands, and each operation code sent from the memory controller to the DRAM will be decoded as one type of command, the present disclosure envisions and describes the use of multiple command tables (e.g., based on different sets of identifying bits for each of a different set of commands), which may be accessed by way of CTIDs referring to the multiple command tables, though a repurposed CAS command (e.g., CAS-PIM command).

FIG. 5 shows a section of the DRAM command table for the repurposed CAS command (referred to herein as CAS-PIM command) where column addresses are repurposed to reference PIM command tables according to one or more aspects of this disclosure. As shown in FIG. 5, the DRAM command, for the CAS-PIM command has a section 502 that includes the identifying bits (e.g., a high, low, and low signal for column addresses CA0, CA1, and CA3 respectively for the first rising clock edge (R1) and a high, high, and high signal for column addresses CA0, CA1, and CA2, respectively for the first falling clock edge (F1)) for the CAS command. However, in the next clock edge (second rising clock edge (R2)), column addresses have been designated for the entry of a set of bits 504 to identify the specific CTID to toggle to. Thus, as shown in FIG. 5, the memory controller may be able to toggle to a given CTID and access the corresponding command table for the CTID to use for decoding for the next set of commands.

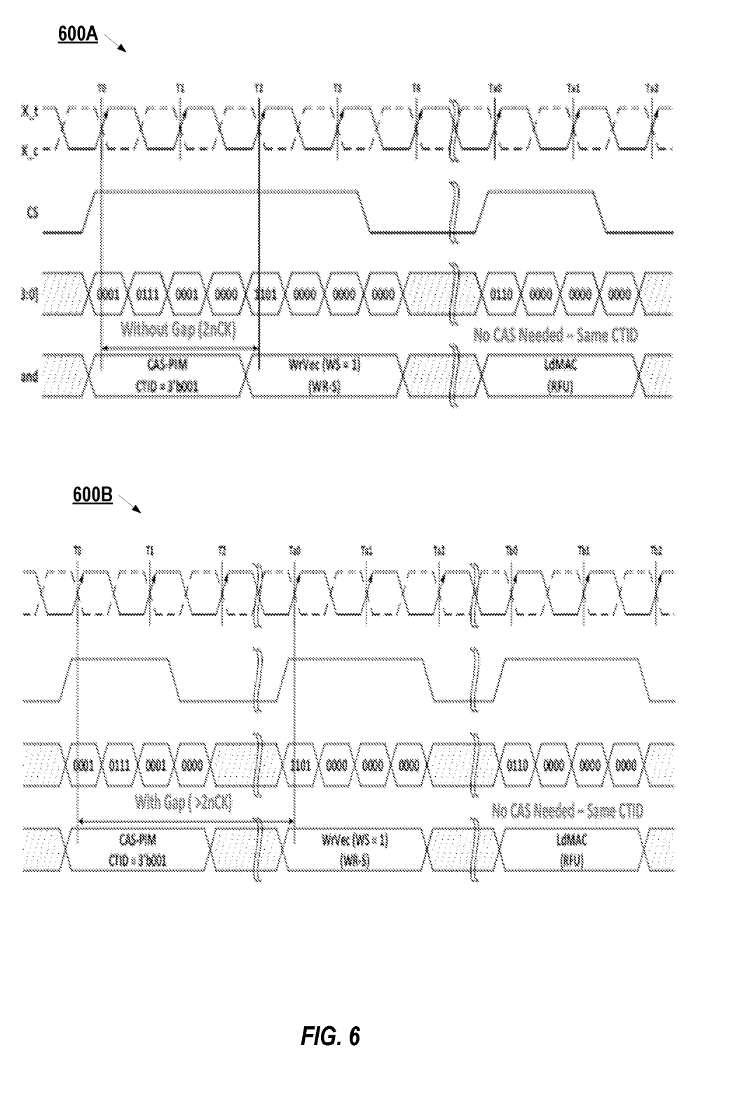

FIG. 6 shows clock cycle diagrams showing the switching between operations with and without command gaps according to one or more aspects of this disclosure. The ability to perform a consecutive set of operations without any gap in between (as shown in scenario 600A) or with a gap in between (as shown in scenario 600B) allows the PIM device to be flexible. For example, the former scenario 600A illustrates execution of a first CAS PIM command and a subsequent PIM command (WrVec) without any gap, and the latter scenario 600B illustrates execution of the first CAS PIM command and a subsequent PIM command (WrVec) with a gap of >2n Ck. That optionality provides the memory controller flexibility for determining whether to schedule the CAS PIM early, in order to defer determining which type of operation or command (e.g., PIM versus non-PIM) to perform later, whether to perform such operations back-to-back, etc.

In some embodiments, the CAS-PIM command is a “sticky command,” as it allows the execution of a single CAS-PIM command orienting the memory controller to a specific CTID to be sufficient for subsequent operations sharing the command table corresponding to that CTID. Thus for both scenarios 600A and 600B, the later subsequent PIM command of LdMAC would not need a separate CAS-PIM operation to be performed prior to the LdMAC command as the LdMAC command is based on a command table sharing the same CTID with the WrVec command before it.

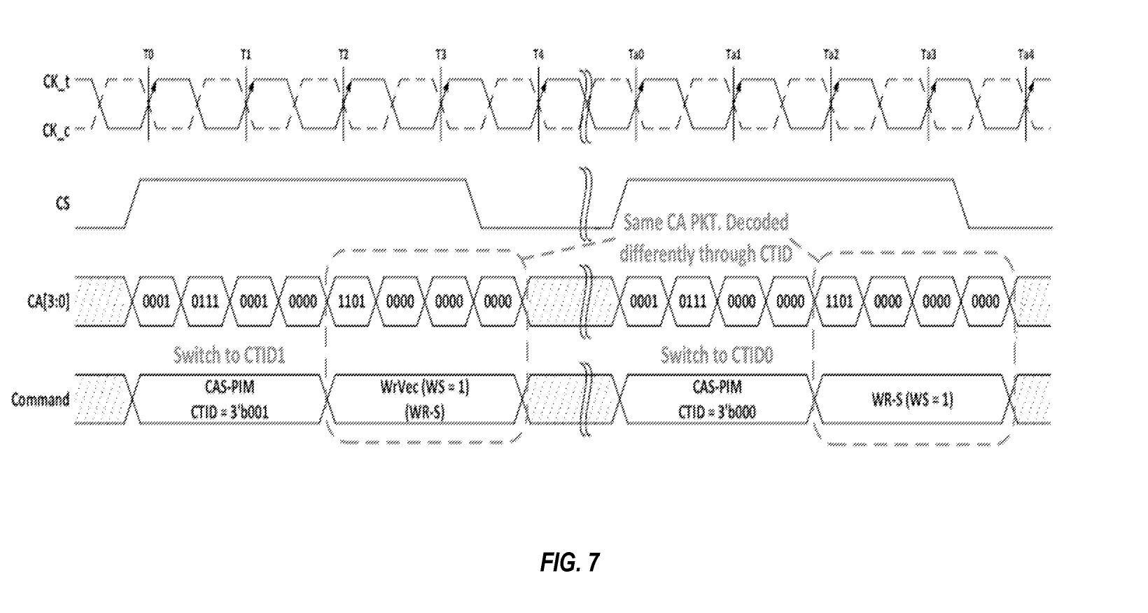

FIG. 7 shows a clock cycle diagram showing the switching between PIM and non-PIM operations using the same column address according to one or more aspects of this disclosure. As shown in FIG. 7, the memory controller causes a switch to a different command table based on a switch from CTID 1 to CTID 0. However, even though there is a switch, the same set or package of column addresses (CAs) are used for the commands, even if the commands are decoded differently. For example, while the first command in the earlier command table (corresponding to CTID 1) was the PIM operation of Wr Vec (see left side), the second command in the subsequent command table (corresponding to CTID 0) is the DRAM command of Write Short (WR-S) (see right side). The ability to maintain the same set of CAs even after the switch to a different command table corresponding to a different CTID allows for the presently disclosed techniques to conserve CA bandwidth and other hardware resources. Depending on the CTID, they commands may be decoded (via identifying bits in the corresponding command table) differently.

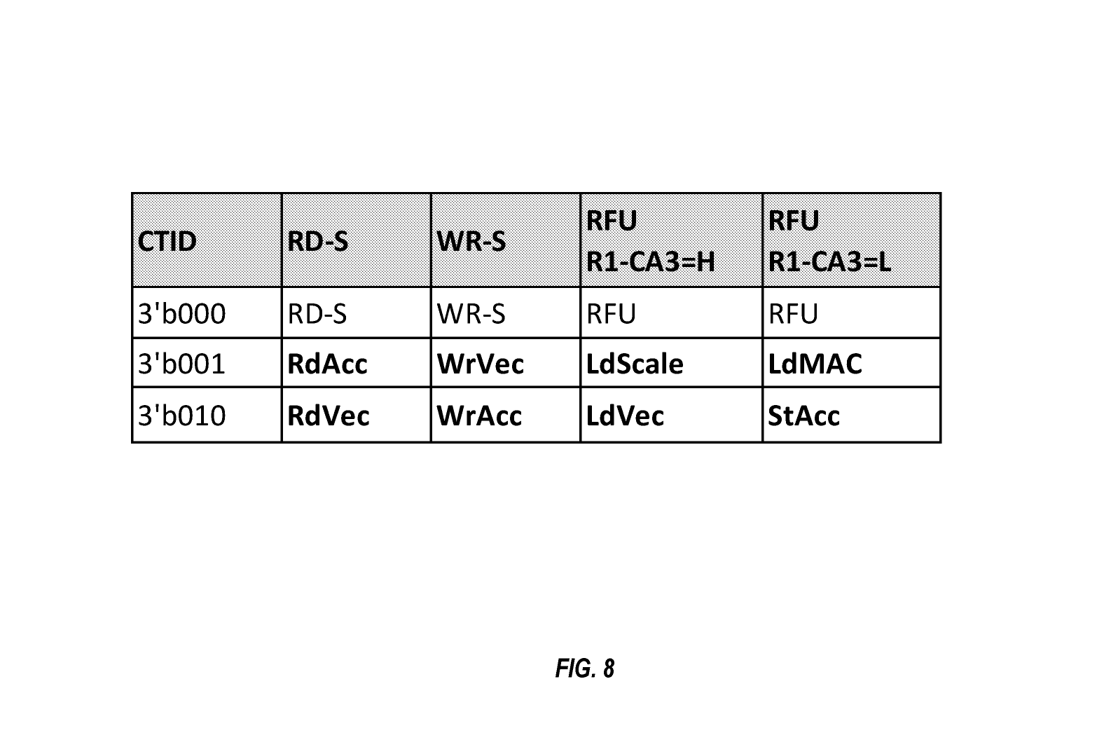

FIG. 8 shows a table mapping PIM operation codes (opcodes) to DRAM commands according to one or more aspects of this disclosure. As previously discussed, PIM operations may include one or more PIM commands that may correspond to, build upon, combine, or otherwise expand existing DRAM commands previously discussed in relation to FIG. 3. Thus, the DRAM commands of Read Short (RD-S), Write Short (WR-S), and Reserved for Future User (RFU) may be mapped to corresponding to PIM operations and/or otherwise repurposed to perform one or more PIM operations. The memory controller may execute the original DRAM commands when in a default command table specified by a default CTID (shown here as CTID 3’b000 or CTID 0), but may switch to executing PIM commands corresponding to otherwise repurposed from the DRAM commands when in another command table prompted by a switch to another CTID (e.g., CTIDs 1 and 2).

For example the PIM operation of Read Register (RdReg), which includes the PIM commands of RdAcc and RdVec, may be mapped to the DRAM command of Read Short (RD-S) because both the PIM operation and the DRAM command perform the similar function of reading data from the registers. Thus, in the command table corresponding to CTID 1 (referred to here as 3’b001), the PIM command RdAcc (for reading data from the accumulator register) is mapped to the DRAM command RD-S, while in the command table corresponding to CTID 2 (referred to here as 3’b010), the PIM command RdVec (for reading data from the vector register) is mapped to the DRAM command RD-S.

Furthermore, the PIM operation of write register (WrReg), which includes the PIM commands WrVec and WrAcc, may be mapped to the DRAM command of Write Short (WR-S) because both the PIM operation and the DRAM command perform the similar function of entering DQ data into the DRAM. Thus, in the command table corresponding to CTID 1 (referred to here as 3’b001), the PIM command WrVec (for writing data into the vector register) is mapped to the DRAM command of WR-S, while in the command table corresponding to CTID 2 (referred to here as 3’b010), the PIM command WrAcc (for writing data into the accumulator register) is mapped to the DRAM command WR-S.

Furthermore, the PIM operations for load and execute (LdExe) and move registers (MovReg) can executed by repurposing the DRAM command Reserved for future use (RFU), which was not previously utilized. The RFU command may be repurposed so that CA based commands are sent. For example, the set of identifying bits for the RFU command can be rearranged so that the identifying bit in the fourth column address (CA3) during the first clock edge (R1) may be determinative of whether the command is to be repurposed for the PIM operations of LdExe or MovReg. As shown in FIG. 3, CA3 at R1 is typically (for DRAM commands) a variable and/or parity bit (V/PAR) and can thus be repurposed for use in distinguishing between LdExe and MovReg PIM operations. If the CA3 bit is a high signal, the memory controller may recognize the command as a LdExe operation. If the CA3 bit is a low signal, the memory controller may recognize the command as a MovReg operation. Corresponding PIM commands for each PIM operation may be performed using the command tables corresponding to CTIDs 1 and 2 and mapped to the RFU command having the specific identifying bit.

Thus, for the LdExe operation, in the command table corresponding to CTID 1 (referred to here as 3’b001), the PIM command LdScale (for loading scaling factor data from memory banks into registers) is mapped to the DRAM command RFU with the high signal in the R1-CA3 address, while in the command table corresponding to CTID 2 (referred to here as 3’b010), the PIM command LdVec (for loading data from memory banks to the vector register) is mapped to the DRAM command RFU with the high signal in the R1-CA3 address. For the MovReg operation, in the command table corresponding to CTID 1 (referred to here as 3’b001), the PIM command LdMAC (for loading matrix data from memory banks to perform the MAC operation (e.g., via the MAC unit)) is mapped to the DRAM command RFU with the low signal in the R1-CA3 address, while in the command table corresponding to CTID 2 (referred to here as 3’b010), the PIM command StAcc (for storing data from the accumulator register to memory banks) is mapped to the DRAM command RFU with the low signal in the R1-CA3 address.

In some embodiment, the Write Short (WR-S), Read Short (RD-S), and RFU are SDRAM commands defined by one or more JDEC standards (LPDDR standards), and are mapped to the aforementioned PIM operation codes (opcodes) of write register (WrReg), read register (RdReg), load execute (LdExe), and move register (MovReg) using the SDRAM commands. It is contemplated that other PIM operations and commands may be similarly mapped to existing DRAM commands.

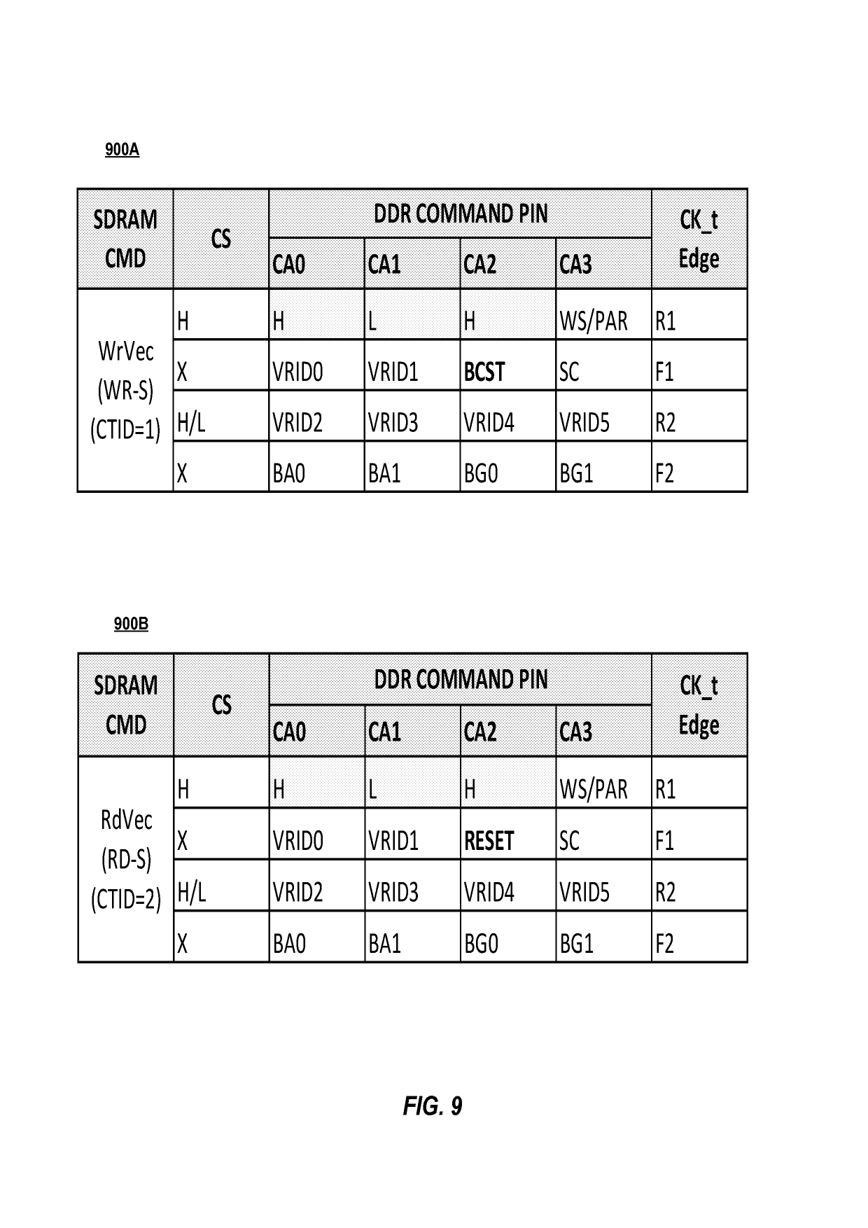

FIG. 9 shows sections of a DRAM command table defining write vector and read vector PIM operations and the broadcast PIM function based on DRAM pins (e.g., identifying bits stored in column addresses for a given clock edge) according to one or more aspects of this disclosure.

For example, section 900A shows the definition of a PIM command of write vector (WrVec) whereas section 900B shows the definition of the PIM command of read vector (RdVec). As shown in FIG. 9, the PIM commands may be accessed by switching to command tables corresponding to CTID 1 (to access the WrVec command) and CTID 2 (to access the RdVec command).

For each PIM command, six bits may be designated to identify the vector register via a vector register ID (VRID) as shown in FIG. 6 (e.g., VRID0, VRID1, VRID2, VRID3, VRID4, and VRID5). As each transaction may be 32 bytes in length, the commands may support up to 2KB sizing based on a 32 byte granule. Thus, for each PIM command – WrVec or RdVec – the VRIDs may allow the memory controller to identify the specific vector registers to which data is written to or read from.

Referring back to FIG. 3, for the DRAM commands of Write Short (WR-S) and Read Short (RD-S), the command pin corresponding to the third column address in the first falling clock edge (CA2-F1) was previously a bit indicative of an auto-precharge (AP) function. In order to repurpose the DRAM commands of Write Short (WR-S) and Read Short (RD-S) to enable the PIM commands of WrVec and RdVec, the auto precharge (AP) bit at CA2-F1 may be repurposed to indicate a broadcast functionality (for the WrVec command) and a reset functionality (for the RdVec command). If the CA2-F1 address now repurposed for the broadcast functionality has a bit that indicates an active state (e.g., a high signal), the memory controller may perform the WrVec command using a combination of memory banks as the destination of the data. Furthermore, the BG and BA bits (BA0, BA1, BG0, BG1) during the second falling clock edge (F2) may be used to designate or specify the memory bank combination being used for the destination of the data. For example, if the CA2-F1 bit corresponding to the broadcast functionality is set to an activate state (e.g., a high signal) and VRIDs indicate a certain register, the memory controller may write data from the register into a combination of (e.g., eight different) memory banks. Also or alternatively, the memory controller may write the data to a single memory bank based on the use of some or one of the BA and BG bits.

In some embodiments, if the CA2-F1 bit corresponding to the broadcast functionality indicates an inactive state (e.g., is set to 0 or a low state), the memory controller may write the data to a single destination (e.g., a single memory bank or processing unit (PU)).

Referring to section 900B, the memory controller executes the read vector (RdVec) PIM command, which is mapped to and repurposed from the DRAM command of Read Short (RD-S). Furthermore, the CA2-F1 bit (which was previously used for the auto precharge function in the DRAM command, RD-S) can be repurposed for the reset functionality. The reset functionality may indicate whether the reading operation is completed. For example, the reset may be set to zero after the RdVec command is executed.

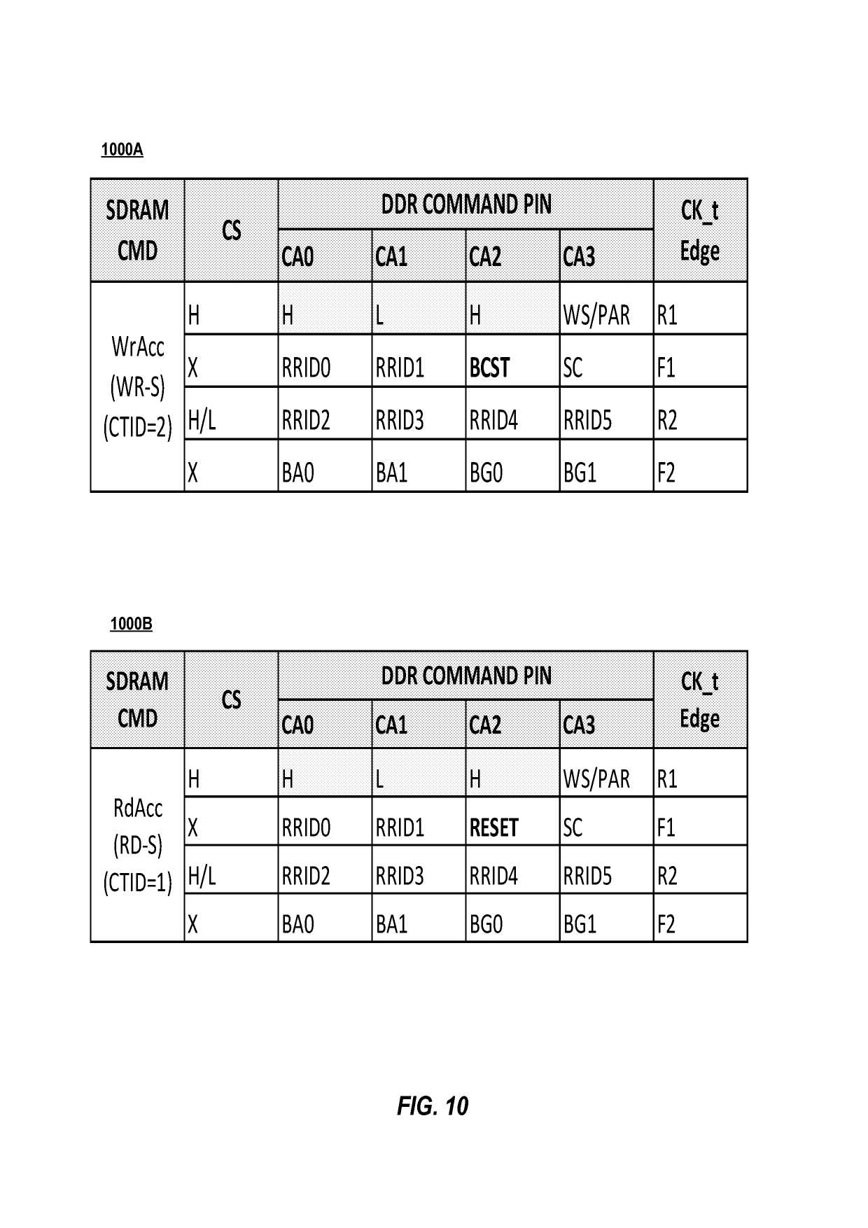

FIG. 10 shows DRAM command tables defining the PIM operations of write accumulator (WrAcc) and read accumulator (RdAcc) and the broadcast and reset functionalities based on a repurposing of DRAM pins according to one or more aspects of this disclosure.

For example, section 1000A shows the definition of a PIM command of write accumulator (WrAcc) whereas section 1000B shows the definition of the PIM command of read accumulator (RdAcc). As shown in FIG. 10, the PIM commands may be accessed by switching to command tables corresponding to CTID 2 (to access the WrAcc command) and CTID 1 (to access the RdAcc command).

For each PIM command, six bits may be designated to identify the read register via a result register ID (RRID) as shown in FIG. 10 (e.g., RRID0, RRID1, RRID2, RRID3, RRID4, and RRID5). As each transaction may be 32 bytes in length, the commands may support up to 2KB sizing based on a 32 byte granule. Thus, for each PIM command – WrAcc or RdAcc – the RRIDs may allow the memory controller to identify the specific accumulator registers from which data is written to or read from.

As previously discussed, the WrAcc and RdAcc PIM commands are mapped to the DRAM commands of Write Short (WR-S) and Read Short (RD-S). For the DRAM commands of WR-S and RD-S, the command pin corresponding to the third column address in the first falling clock edge (CA2-F1) was previously a bit indicative of an auto-precharge (AP) function. In order to repurpose the DRAM commands of WR-S and RD-S to enable the PIM commands of WrAcc and RdAcc, the auto precharge (AP) bit at CA2-F1 may be repurposed to indicate a broadcast functionality (for the WrAcc command) and a reset functionality (for the RdAcc command). If the CA2-F1 address now repurposed for the broadcast functionality has a bit that indicates an active state (e.g., a high signal), the memory controller may perform the WrAcc command using a combination of memory banks as the destination of the data. Furthermore, the BG and BA bits (BA0, BA1, BG0, BG1) during the second falling clock edge (F2) may be used to designate or specify the memory bank combination being used for the destination of the data. For example, if the CA2-F1 bit corresponding to the broadcast functionality is set to an active state (e.g., a high signal) and RRIDs indicate a certain accumulator register, the memory controller may read data from said accumulator register into a combination of (e.g., eight different) memory banks. Also or alternatively, the memory controller may write the data to a single memory bank based on the use of some or one of the BA and BG bits.

In some embodiments, if the CA2-F1 bit corresponding to the broadcast functionality indicates an inactive state (e.g., is set to 0 or a low state), the memory controller may write the data to a single destination (e.g., a single memory bank or processing unit (PU)).

Referring to section 1000B, the memory controller executes the read accumulator (RdAcc) PIM command, which is mapped to and repurposed from the DRAM command of RD-S. Furthermore, the CA2-F1 bit (which was previously used for the auto precharge function in the DRAM command, RD-S) can be repurposed for the reset functionality. The reset functionality may indicate whether the reading operation is completed. For example, the reset may be set to zero after the RdAcc command is executed.

Thus, when an accumulation is performed, the accumulated data values may be read (e.g., to an SoC), prompting the reset value to be set to 0 so that the memory controller can proceed doing the next set of accumulations, and load and execute functions.

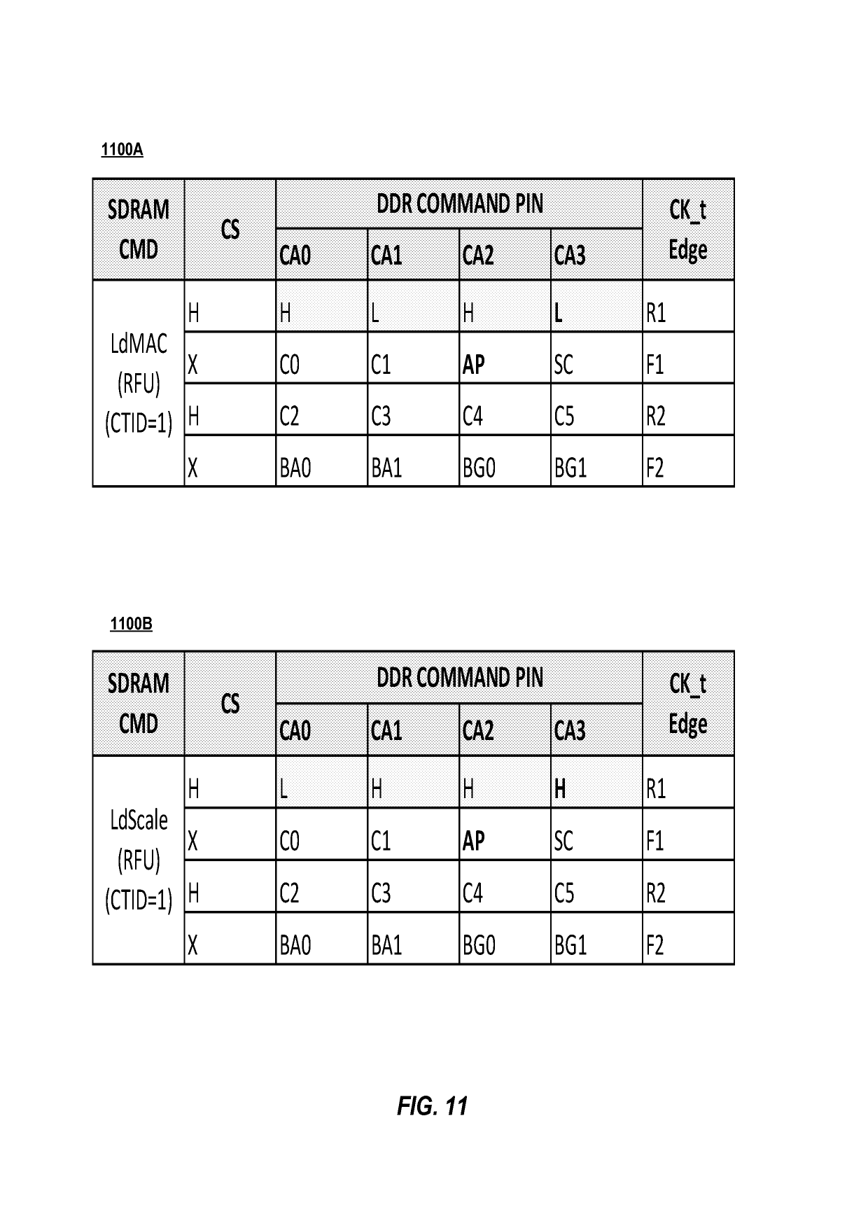

FIG. 11 shows sections of a DRAM command table defining the PIM operation of load and execute (LdExe) based on a repurposing of DRAM pins according to one or more aspects of this disclosure.

For example, section 1100A shows the definition of a PIM command of load and MAC (LdMAC) whereas section 1100B shows the definition of the PIM command of load and scale (LdScale). As shown in FIG. 10, the PIM commands may be accessed by switching to command tables corresponding to other CTIDs (e.g., CTID 1 to access the LdMAC command and CTID 1 to access the LdScale command).

As previously discussed in relation to FIG. 8, the load and execute PIM operation (including the ldMAC and ldScale commands) are based on a repurposing of the RFU command. Referring to FIG. 3, the RFU command in the DRAM command table can have a variable and/or parity (V/PAR) bit but for the third column address during the first rising edge (R1-CA3), and is therefore not traditionally part of the set of identifying bits for executing the DRAM command of RFU. The repurposing of the RFU command for the load and execute PIM operations may thus involve using the R1- CA3 bit to differentiate between the loadMAC and loadScale commands for the load and execute PIM operations. Thus, in some embodiments, if the R1-CA3 bit is a low (L) signal (as shown in section 1100A), the memory controller may identify as and execute the loadMAC command. Alternatively, if the R1-CA3 bit is a high (H) signal (as shown in section 1100B), the memory controller may identify and execute the loadScale command.

Furthermore, additional bits that were previously variable bits for the RFU command (and therefore not part of the set of identifying bits for the RFU command in the DRAM command table) may be repurposed for use in the load and execute PIM operation. Specifically, six bits - C0, C1, C2, C3, C4, and C5 – corresponding to column addresses CA0 and CA1 during the first falling clock edge (F1) and column addresses CA0, CA1, CA2, and CA3 during the second rising clock edge (R2), respectively, may be used to designate memory banks, registers, and/or other processing units (PU) involved during the load and execute commands. Additionally, four bits that were previously variable bits for the RFU command – shown here as BA0, BA1, BG0, and BG1 – may be used to determine the combination of destination memory banks involved in the load and execute operation. In some embodiments, the bit corresponding to the second column address and the first falling clock edge (CA2-F1), may be used to differentiate between whether to perform an autoprecharge (AP) of the destination memory banks involved in the load and execute operations. The CA2-F1 bit may set to an activate state (e.g., a “1” or a high signal) to trigger the autoprecharge function and may be set to an inactivate state (e.g., a “0” or a low signal) to not trigger the autoprecharge function.

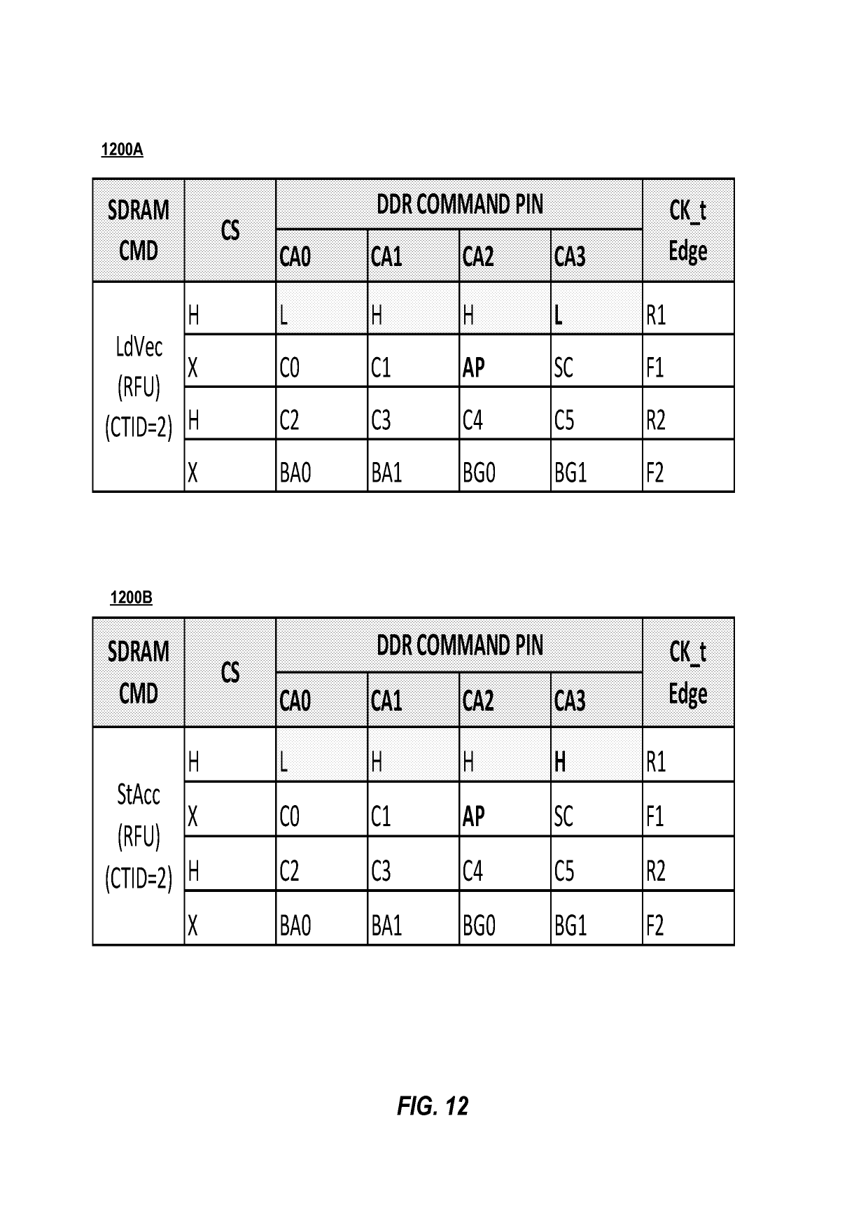

FIG. 12 shows sections of a DRAM command table defining the PIM commands associated with the PIM operation of move register (MovReg) based on a repurposing of DRAM pins according to one or more aspects of this disclosure. As previously discussed, the MovReg PIM operation may include the PIM commands of load vector (LdVec) and store accumulator (StAcc) and may be mapped to the RFU command of the DRAM command table.

The MovReg operation involves movement of data from a source (e.g., a memory bank) and a destination (e.g., a register). In some embodiments, the memory bank may be identified using column address (CA) bits – C0, C1, C2, C3, C4, and C5 – as previously described and shown in sections 1200A-1200B. The destination of the data may be a register identifiable by a register ID. The specific register ID may be determined by way of an internal counter or state machine (e.g., starting from zero for clock cycles or other periods after execution of the MovReg commands). For example, the MovReg operations may involve indicating the memory bank through the C0-C5 bits, but them relying on an internal counter to track (e.g., through clock cycles or other predefined periods), a corresponding register ID, where the register ID increases by +1 after each period. By relying on a counter, rather than using up additional column addresses to indicate the specific register destination, techniques disclosed herein further conserve memory resources for the implementation of PIM operations.

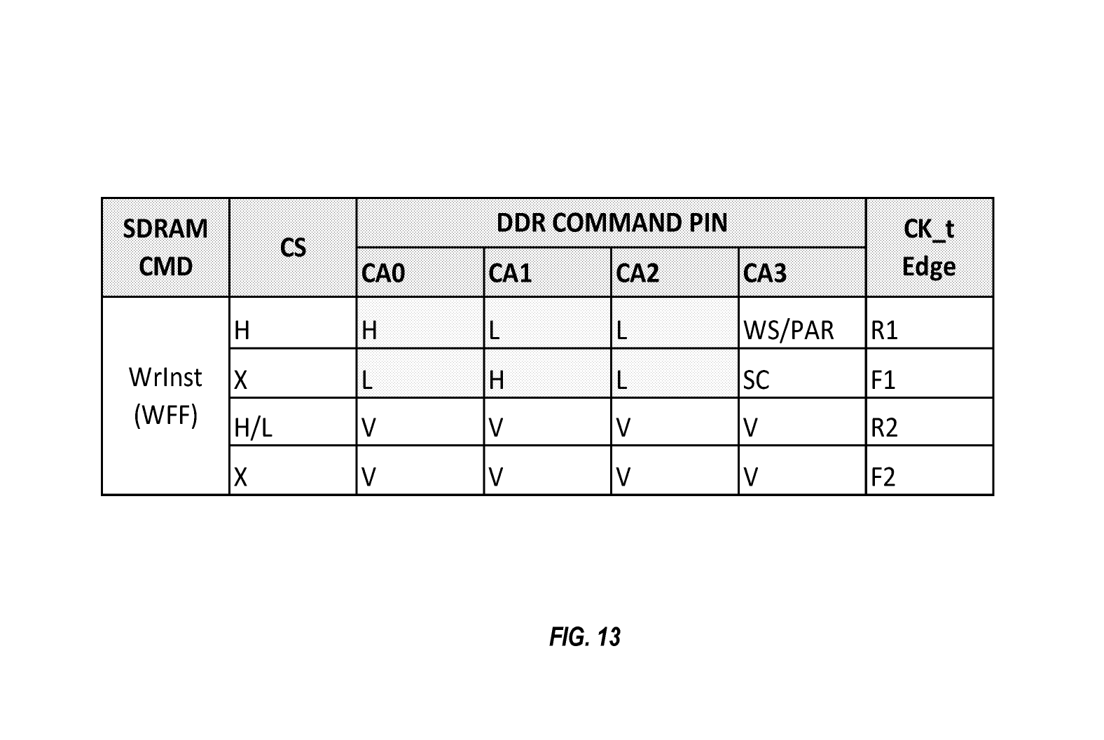

FIG. 13 shows how a DRAM command table can be reprogrammed for new PIM functions according to one or more aspects of this disclosure. The reprogrammable aspect allows for the scalability for the evolving nature of PIM operations.

Although the PIM command of Write Instruction (WrInst) can be used to program new commands, the WrInst command is typically unique and cannot be reprogrammed, preventing its reprogrammability. TO overcome this, in various embodiments, the DRAM command of Write FIFO (WFF) may be used in combination with CAS-PIM command. As shown and explained previously in relation to FIG. 3, the WFF is a DRAM command that was dependent on the CTID, such that the command is typically accessed by the memory controller switching to maintaining the DRAM command table associated with a defaul CTID. In various embodiments, the WFF may be reconfigured to not be dependent on the command table (e.g., become CTID-independent) so as to override the function to lose the ability to write instructions.

For example, the memory controller may reprogram the command table by executing the CAS PIM command to switch to a desired CTID. Then, the memory controller may identify and execute the write FIFO (WFF) command to reprogram the corresponding command table to a different CTID value, thus designating a different CTID value for the command table, and allowing the WFF command to be able to reprogram and take on a new function.

The reprogramming aspect may allow more commands to be supported, and may allow the adaptability and customization of combinations of commands for use across different SoC clients and applications.

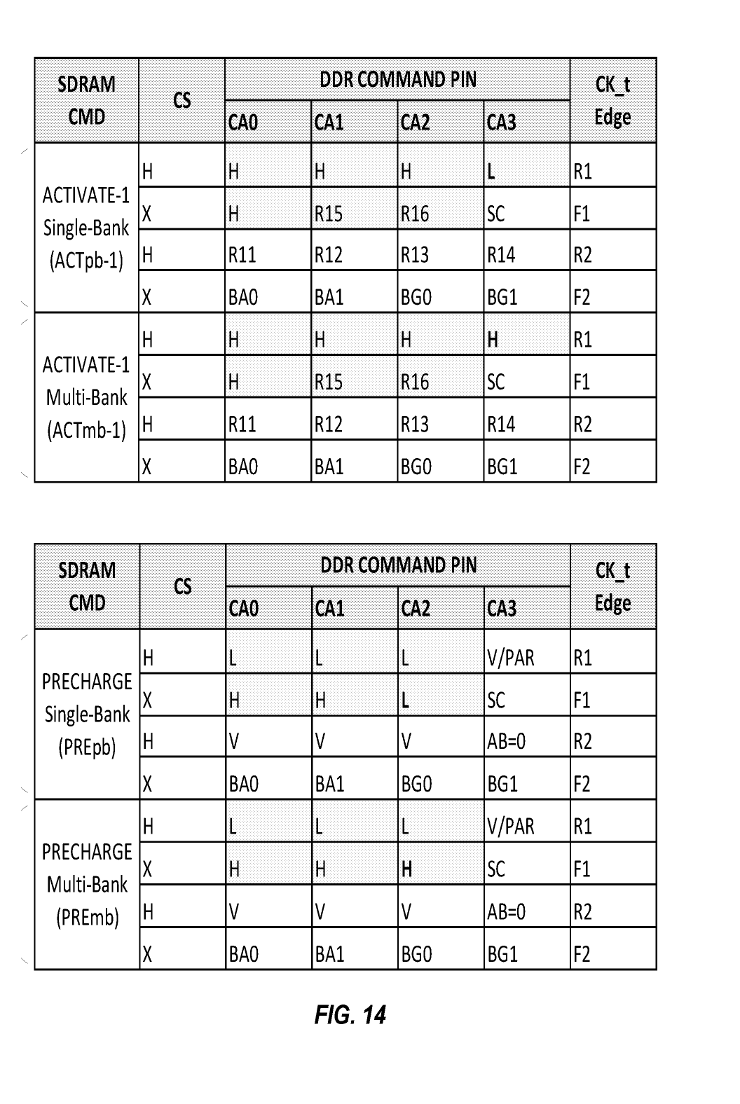

FIG. 14 shows sections of a DRAM command table defining PIM operations for activating and precharging single memory banks and multiple memory banks based on a repurposing of DRAM pins according to one or more aspects of this disclosure. The PIM operations for activating and precharging may be mapped to or repurposed from the DRAM commands of Activate-1 (ACT-1), Activate-2 (ACT-2), and Precharge (PRE). As shown and previously explained in relation to FIG. 3, such DRAM functions are CTID-independent and, in some embodiments, the repurposed commands for PIM operations are also maintained as CTID-independent. By maintaining the PIM operation for activation and precharging of memory banks as CTID-independent, the memory controller can allow for memory bank activation and precharging to be done in the background of, or parallel to, other ongoing operations (e.g., PIM operations). For example, in some embodiments, the PIM commands ACTpb (for activating single memory banks) and PREpb (for activating single memory banks) may occur in the background of (e.g., concurrently with) other PIM operations, and the PIM commands ACTmb (for activating multiple memory banks) and PREpb (for precharging multiple memory banks) may occur in the background of (e.g., concurrently with) regular (e.g., non-PIM) operations. Furthermore, by allowing precharge and activation functions to occur concurrently with other operations, various embodiments are better able to support efficient interleaving and concurrent switching between different operations, by allowing memory banks used for a subsequent operation to be activated and precharged while a current operation is being executed.

As shown in sections 1400A-B of FIG. 14, the DRAM commands for ACT-1 and ACT-2 may be repurposed to support the activate commands for PIM operations as well as distinguish between activating a single bank and activating multiple banks. Referring back to FIG. 3, the section of the DRAM command table corresponding to the ACT-1 and ACT-2 DRAM commands has a fourth column address during the first rising clock edge (CA3-R1) storing a parity bit (and is thus not part of the set of identifying bits for the ACT-1 or ACT-2 commands). Thus, in some embodiments, the ACT-1 command can be repurposed so that the address CA3-R1 can be used to differentiate between a PIM command to activate multiple memory banks (ACTmb) from a PIM command to activate a single memory bank (ACTpb). For example, if the bit in the CA3-R1 address is a low (L) signal, as shown in section 1400A, the memory controller may interpret this command as a ACTpb command and execute accordingly. However, if the bit in the CA3-R1 address is a high (H) signal, as shown in section 1400B, the memory controller may interpret this command as a ACTmb command and execute accordingly. In another embopdiment, the bit stored in the CS-R2 pin may be used to differentiate between an ACTmb and an ACTpb command.

As shown in sections 1400C-D of FIG. 14, the DRAM command, PRE, may be repurposed to support the precharge commands for PIM operations as well as distinguish between precharging a single bank and precharging multiple banks. Referring back to FIG. 3, the section of the DRAM command table for the PRE command, the third column address during the first falling clock edge (CA2-F1) typically stores a variable bit (and is thus not part of the set of identifying bits for the PRE command). Thus, in some embodiments, the PRE command can be repurposed so that the address CA2-F1 can be used to store a bit that differentiates between a PIM command to precharge multiple memory banks (PREmb) from a PIM command to precharge a single memory bank (PREpb). For example, if the bit in the CA2-F1 address is a low (L) signal, as shown in section 1400C, the memory controller may interpret this command as a PREpb command and execute accordingly. However, if the bit in the CA2-F1 address is a high (H) signal, as shown in section 1400D, the memory controller may interpret this command as a PREmb command and execute accordingly.

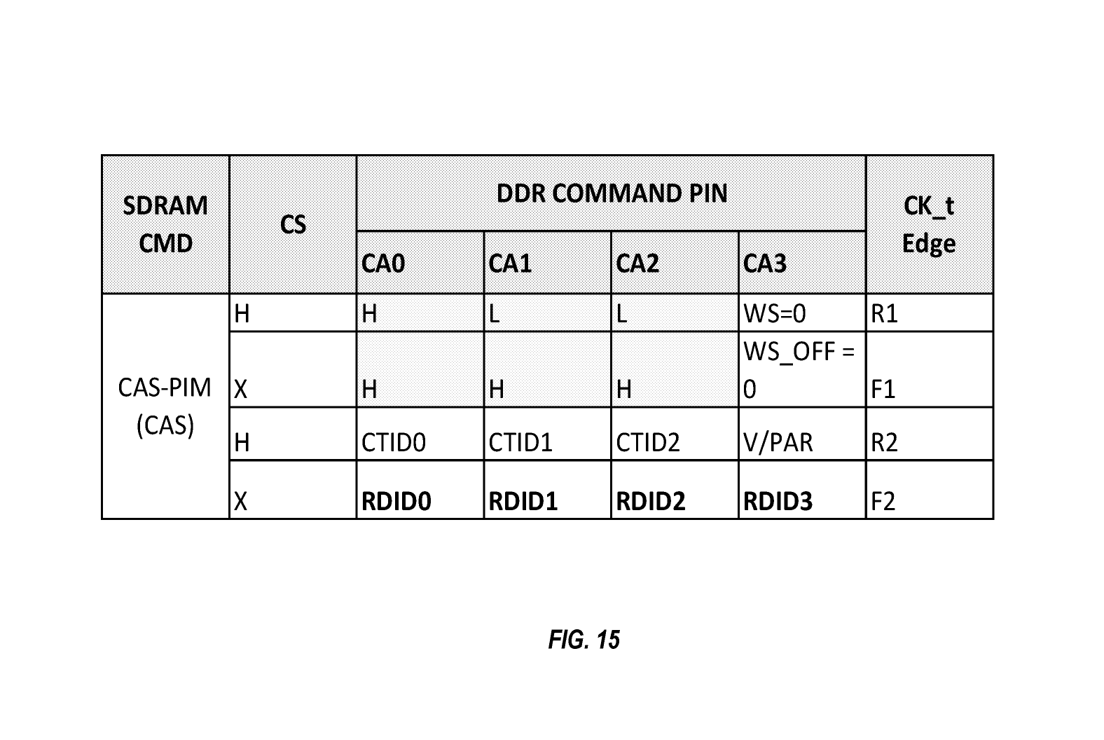

FIG. 15 shows a section of a DRAM command table being used to extend register size for new PIM functions according to one or more aspects of this disclosure. In some embodiments, the memory controller may execute the previously discussed CAS-PIM command to extend the register size (e.g., from 2 KB to 32 KB). For example, as shown in the section of the DRAM command table corresponding to the CAS-PIM function, column addresses CA0, CA1, CA2, and CA3 during the second falling clock edge may be used to store 4 bit register domain IDs (RDID). Each RDID may refer to a register domain that can be used to group up to 0-2kb of all registers. Thus, with 16 possible register domains, based on 16 RDIDs formed using the 4 bits allotted, the register size may be extended to up to 32 kb. While executing the CAS-PIM command, the memory controller may use the RDID bits (RDID0, RDID0, RDID0, and RDID0) to switch between the registered domains.

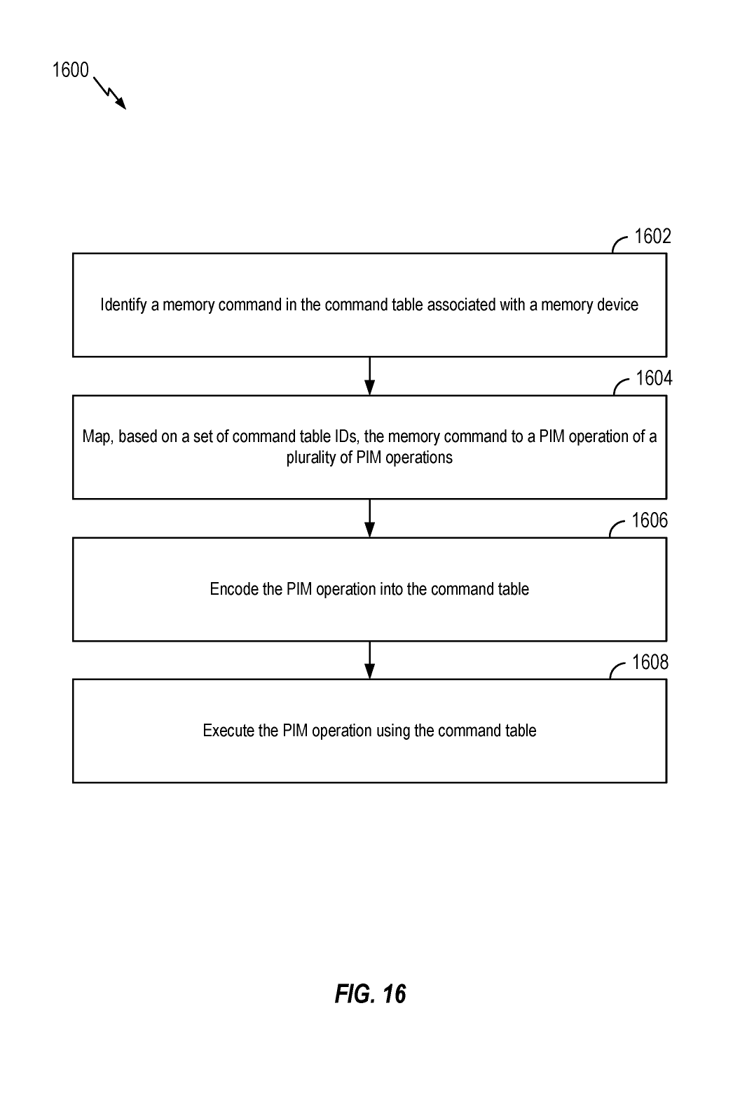

FIG. 16 shows a flow chart of an example process 1600 for implementing PIM operations using a DRAM command table according to one or more aspects of this disclosure. Process 1600 may be performable by or at a processing-in memory (PIM) device that supports the mapping and implementation of PIM operations using a DRAM command table according to aspects described herein. For example, process 1600 may be performed by a memory controller of the PIM device, such as but not limited to memory controller 106.

At step 1602, the memory controller may identify a memory command in a command table associated with a memory device. For example, the memory device may be a DRAM, for which the memory command in the command table may be one of a plurality of DRAM commands, such as but not limited to the DRAM commands shown and previously explained in relation to FIG. 3. In some embodiments, such memory commands may be commands or operations typically performed by low power memory devices as specified in JEDEC standards, such as but not limited to LPDDR standards for the LPDDR memory device. In some embodiments, the memory controller may identify the memory command by decoding (e.g., via a command table decoder 210), a set of identification bits from the command table associated with the memory command. For example, for the DRAM command Read Short (RD-S) in FIG. 3, the set of identification bits may include high, high, and low for the data pins CA0-R1, CA1-R1, and CA2-R1. The memory controller can thus recognize the set of identification bits as pertaining to the RD-S command.

At step 1604, the memory controller may map, based on a set of command table IDs, the memory command (identified from step 1602) to a PIM operation of a plurality of PIM operations. For example, as previously discussed, each command table ID may correspond to a command table with reconfigured and/or repurposed commands, with each command having a unique set of identifying bits to enable a memory controller to identify and execute the command. For example, the memory controller may recognize the sets of identifying bits as corresponding to the memory command (e.g., a DRAM command as shown in FIG. 3) based on determining a certain command table ID (CTID), such as a default CTID (e.g., CTID 0). However, the implementation of additional or alternative CTIDs (e.g., CTID 1, CTID 2, CTID 3, etc.) may be used to repurpose identifying bits or allow new sets of identifying bits for the execution of new PIM commands or new PIM operations comprising PIM commands. For example, a set of one or more CTIDs may be used to refer to one or more respective command tables having the sets of identifying bits for one or more PIM commands for a PIM operation. In some embodiments, the one or more respective command tables corresponding to the one or more CTIDs may merely be sections of or subtables of a command table associated with the memory device (e.g., DRAM). As used herein, a command table associated with the memory device may refer to the one or more command tables corresponding to the one or more CTIDs in aggregate.

In various aspects, the memory controller may toggle or switch from one CTID to another CTID by performing the clock auto synchronization (CAS) operation (also referred to, in some aspects, as column address strobe operation). For example, prior to identifying the memory command in the command table, the memory controller may execute a CAS - PIM command in the command table, such the CAS-PIM command previously discussed in relation to FIG. 5. The memory controller may determine, based on the CAS-PIM command, a command table ID used for mapping the memory command to the PIM operation (e.g., based on the CTID0, CTID1, and CTID2 bits in the command table).

In some embodiments, PIM operations may correspond to, build upon, combine, or otherwise expand existing DRAM memory commands shown in FIG. 3. For example, PIM operations may include the Write Register (WrReg) operation, the Read Register (RdReg) operation, the load and execute (LdExe) operation), and the move register (MovReg) operation. As previously discussed in relation to FIGS. 8-13, the PIM operation, WrReg, which includes the PIM commands, WrVec and WrAcc, may be mapped to the DRAM command, WR-S. The PIM operation, RdReg, which includes the PIM commands, RdVec and RdAcc, may be mapped to the DRAM command, RD-S. However, adjustments (as reflected in the command tables associated with the PIM operation but absent in the command table associated with the memory command) may involve using various data pins (e.g., previously storing variable and/or non-identifiable bits) to designate new functionalities (e.g., broadcast, reset), and identify registers, and designate memory banks.

The PIM operation, LdExe, which may include the PIM commands, LdMAC, LdMul, and LdScale, may be mapped to the DRAM command, RFU. The PIM operation, MovReg, which may include the PIM commands, StAcc and LdVec, may be mapped to the DRAM command, RFU. However, an adjustment (as reflected in the command table associated with the PIM operation) may involve using the bit stored in a data pin (e.g., CA3-R1), which previously a variable and/or a parity bit, to differentiate between the different PIM commands.

At step 1606, the memory controller may encode the PIM operation into the command table. For example, the PIM operation, including any PIM commands associated with the PIM operation, may have a different set of identifying bits leveraging different column addresses and other data pins of the command table. Encoding the PIM operation into the command table may thus include inputting, into the command table, such set of identification bits (second set of identification bits) associated with the PIM operation.

For example, in some embodiments, if the memory command is a read short (RD-S) command, the PIM operation mapped to the RD-S command may be a read register (RdReg) operation. Encoding the PIM operation into the command table may include: encoding, using a first command table ID of the set of command table IDs, a read accumulate (RdAcc) command into the command table; and encoding, using a second command table ID of the set of command table IDs, a read vector (RdVec) command into the command table.

In some embodiments, if the memory command is a write S command, the PIM operation mapped to the write S command can be a write register (WrReg) operation. Encoding the PIM operation into the command table may include: encoding, using a first command table ID of the set of command table IDs, a write vector (WrVec) command into the command table; and encoding, using a second command table ID of the set of command table IDs, a write accumulate (WrAcc) command into the command table.

In some embodiments, if the memory command is a reserved for future use (RFU) command, the PIM command mapped to the RFU may be a load and execute operation (e.g., based on a differentiating bit entered into a data pin previously storing variable bits for the memory command). Encoding the PIM operation into the command table may include: encoding, using a first command table ID of the set of command table IDs, a Load Scale (LdScale) command into the command table; and encoding, using a second command table ID of the set of command table IDs, a load vector (LdVec) command into the command table.

In some embodiments, if the memory command is a reserved for future use (RFU) command, the PIM command mapped to the RFU may be a move register (MovReg) operation (e.g., based on a differentiating bit entered into a data pin previously storing variable bits for the memory command). Encoding the PIM operation into the command table may include: encoding, using a first command table ID of the set of command table IDs, a Load MAC (LdMAC) command into the command table; and encoding, using a second command table ID of the set of command table IDs, a store accumulate (StAcc) command into the command table.

At step 1608, the memory controller may execute the PIM operation using the command table. For example, after encoding the set of identifying bits pertaining to the PIM operation, the memory controller may execute the PIM operation based on information provided by the set. For example, for a MovReg operation, the set of identifying bits may encode (e.g., using the C0-C5 bits), the source memory bank from which data is to moved. As another example, for the WrAcc commands, the RRID0-RRID5 bits may identify the read register from which data is to be written.

In some embodiments, the process 1600 may further include identifying an activation function or a precharge function in the command table associated with the memory device. The memory controller may determine that the activation function or the precharge function is directed to multiple memory banks in the memory device based on an identification bit in the command table (e.g., stored in a data pin that was previously did not store an identifying bit for the corresponding DRAM command). The memory controller may then execute the activation function or the precharge function to respectively activate or precharge the multiple banks.

In some embodiments, the memory controller may extend the register size of the memory device by executing the CAS-PIM command. for example, the command table may further include a set of register domain IDs (RDIDs), where each register domain ID refers to a register domain that groups registers accumulating to 2kb of data. Executing the CAS-PIM command comprises accessing, based on each RDID, a subset of registers for additional data storage.

In some embodiments, the memory controller may execute operations in a manner than conserves memory resources (e.g., column addresses). For example, in some embodiments, prior to executing the PIM operation, the memory controller may execute a non-PIM operation. The non-PIM operation may be encoded into the command table using a command table ID that is associated with mapping (e.g., is the same as the one used for) the PIM operation. Furthermore, by sharing the same command table ID, the PIM operation may be executed using the same column address (CA) associated with the execution of the non-PIM operation.

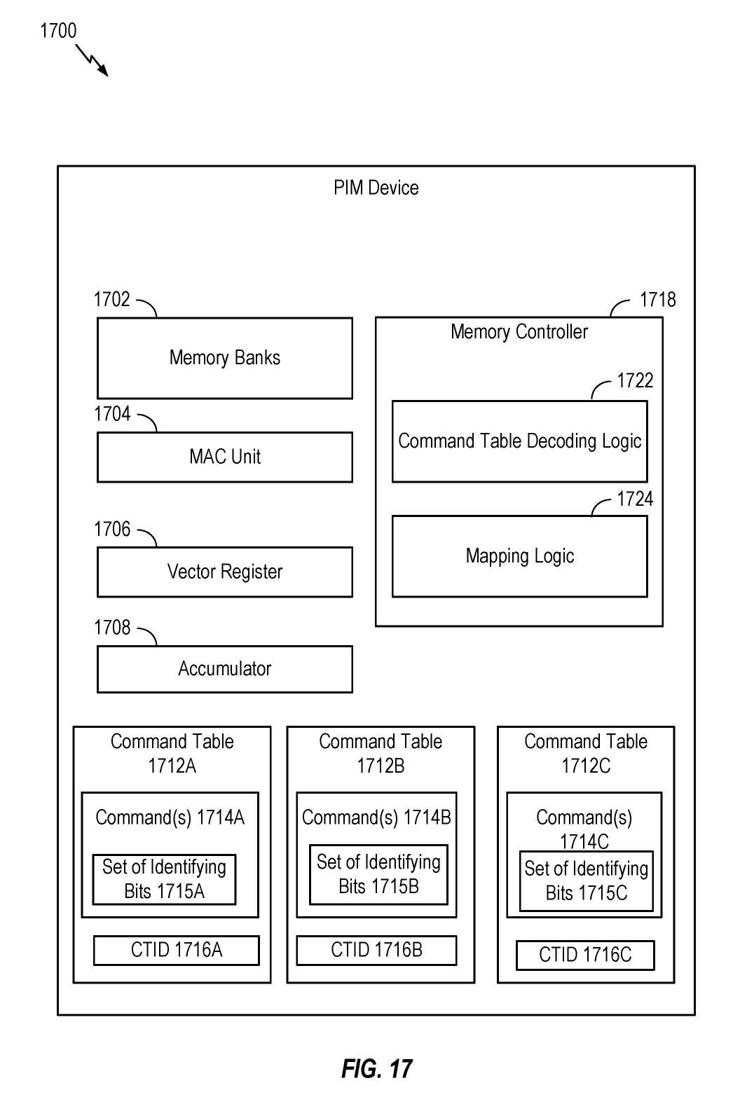

FIG. 17 shows a block diagram of an example PIM device configured to implement PIM operations using a command table associated with a memory device (e.g., a DRAM) according to one or more aspects of this disclosure.

Device 1700 includes a vector register 1706 configured to store input vectors during processing. An accumulator 1708 couples to a MAC unit 1704 through a dedicated path and accumulates results from matrix-vector operations.

Memory controller 1718 coordinates operations across device 1700 through a control bus. Controller 1718 includes command table decoding logic 1722 (e.g., such as but not limited to command table decoder 210) that can decode commands from a command table (e.g., one of command tables 1712A-C) by recognizing a set of identifying bits stored in various data pins of the command table as pertaining to a known command.

Furthermore, controller 1718 may include a mapping logic 1724 that can map memory commands from a command table to corresponding PIM commands. The mapping may be based on a look up table and/or a repurposing a set of identifying bits of a memory command to that of the corresponding PIM command. In some embodiments, the mapped PIM command may utilize new identifying bits in data pins that were previously not utilized in the corresponding memory command.

The memory controller 1718 may rely on command tables 1712A-1712C identifiable by a command table ID (CTID 1716A-1716C, respectively)) that repurpose existing data pins used for memory commands to perform new commands associated with PIM operations. The memory controller 1718 may switch between command tables by way of a CAS-PIM function as previously described. Each command table may have a set of commands 1714A-1714C that can be decoded via a respective set of identifying bits 1715A-1715C, respectively stored in data pins.

In operation, device 1700 performs process 1600 by having the memory controller 1718 identify a memory command (e.g., command 1714A) in a command table (e.g., command table 1712A) associated with the memory device 1700. The memory controller may identify the memory command by way of encoding the set of identifying bits 1715A of the command 1714A (e.g., using command table decoding logic 1722). In some aspects, command table 1712A may be associated with memory commands 1714A whereas command table 1712B and 1712C may be associated with PIM commands. The memory controller 1718 may map, based on a set of command table IDs (e.g., CTID 1716A associated with the command table 1712A for the memory command 1714A and CTID 1716B associated with a command table 1712B for a corresponding PIM command 1714B), the memory command 1714A to a PIM operation of a plurality of PIM operations. For example, the memory controller 1718 may use the mapping logic 1724 to map the memory command 1714A to a PIM command 1714B associated with the PIM operation. The memory controller 1718 may then encode the PIM operation into the command table, for example, by using the set of identifying bits 1715C associated with the PIM command 1715B and inputting that set into data pins of one of command tables 1712A or 1712B. The memory controller 1718 may then execute the PIM operation using the command tables 1712A-1712B.

In one or more aspects, techniques for mapping, defining, and implementing PIM operations using a command table may include additional aspects, such as any single aspect or any combination of aspects described below or in connection with one or more other processes described elsewhere herein. Additionally, an apparatus may perform or operate according to one or more aspects as described below. In some implementations, the apparatus includes a processing-in-memory device. In some implementations, the apparatus includes at least one processor and a memory coupled to the processor. The processor may be configured to perform operations described herein with respect to the apparatus. In some other implementations, the apparatus may include a non-transitory computer-readable medium having program code recorded thereon, the program code being executable by a computer for causing the computer to perform operations described herein. In some implementations, the apparatus may include one or more means configured to perform operations described herein.

In a first aspect, a method for defining PIM operations using a command table associated with a memory device includes: identifying, by a memory controller, a memory command in the command table associated with the memory device; mapping, based on a set of command table IDs, the memory command to a PIM operation of a plurality of PIM operations; encode the PIM operation into the command table; and executing, by the memory controller, the PIM operation using the command table.

In a second aspect, in combination with the first aspect, identifying the memory command includes decoding, from the command table, a first set of identification bits associated with the memory command.

In a third aspect, in combination with the first aspect or the second aspect, encoding the PIM operation into the command table includes inputting, into the command table, a second set of identification bits associated with the PIM operation.

In a fourth aspect, in combination with any one of the first aspect through the third aspect, the method further includes, prior to identifying the memory command in the command table: executing, by the memory controller, a clock auto synchronization - PIM (CAS-PIM) command in the command table; and determining, based on the CAS-PIM command, a command table ID used for mapping the memory command to the PIM operation.

In a fifth aspect, in combination with any one of the first aspect through the fourth aspect, the command table further includes a set of register domain IDs (RDIDs). Furthermore, executing the CAS-PIM command includes accessing, based on each RDID, a subset of registers for additional data storage.

In a sixth aspect, in combination with any one of the first aspect through the fifth aspect, the method further includes, prior to executing the PIM operation: executing a non-PIM operation. The non-PIM operation may be encoded into the command table using a command table ID that is associated with mapping the PIM operation. The PIM operation may be executed using a column address (CA) associated with the execution of the non-PIM operation.

In a seventh aspect, in combination with any one of the first aspect through the sixth aspect, the memory command is a read short (RD-S) command. The PIM operation mapped to the RD-S command is a read register (RdReg) operation. Furthermore, encoding the PIM operation into the command table includes: encoding, using a first command table ID of the set of command table IDs, a read accumulate command into the command table; and encoding, using a second command table ID of the set of command table IDs, a read vector command into the command table.

In a eighth aspect, in combination with any one of the first aspect through the seventh aspect, the memory command is a write short (WR-S) command. The PIM operation mapped to the WR-S command is a write register (WrReg) operation. Furthermore, encoding the PIM operation into the command table includes: encoding, using a first command table ID of the set of command table IDs, a write vector (WrVec) command into the command table; and encoding, using a second command table ID of the set of command table IDs, a write accumulate (WrAcc) command into the command table.

In a ninth aspect, in combination with any one of the first aspect through the eighth aspect, the memory command is a reserved for future use (RFU) command. The PIM command mapped to the RFU is a load and execute (LdExe) operation. Furthermore, encoding the PIM operation into the command table includes: encoding, using a first command table ID of the set of command table IDs, a load scale (LdScale) command into the command table; and encoding, using a second command table ID of the set of command table IDs, a load vector (LdVec) commend into the command table.

In a tenth aspect, in combination with any one of the first aspect through the ninth aspect, the memory command is a reserved for future use (RFU) command. The PIM command mapped to the RFU is a move register (MovReg) operation. Furthermore, encoding the PIM operation into the command table includes: encoding, using a first command table ID of the set of command table IDs, a load MAC (LdMAC) command into the command table; and encoding, using a second command table ID of the set of command table IDs, a store accumulate (StAcc) command into the command table.

In an eleventh aspect, in combination with any one of the first aspect through the tenth aspect, the method further includes: identifying an activation function or a precharge function in the command table associated with the memory device; determining that the activation function or the precharge function is directed to multiple memory banks in the memory device based on an identification bit in the command table; and executing the activation function or the precharge function to respectively activate or precharge the multiple banks.

In a twelfth aspect, an apparatus for implementing PIM operations using a DRAM command table is disclosed. The apparatus includes: a memory device including one or more registers and configured to store PIM contexts; and a memory controller coupled to the memory, and configured to perform operations, the operations including: identifying a memory command in the command table associated with the memory device; mapping, based on a set of command table IDs, the memory command to a PIM operation of a plurality of PIM operations; encode the PIM operation into the command table; and executing, by the memory controller, the PIM operation using the command table.

In a thirteenth aspect, in combination with the twelfth aspect, the memory controller is configured to identify the memory command by decoding, from the command table, a first set of identification bits associated with the memory command.

In a fourteenth aspect, in combination with any one of the twelfth aspect or the thirteenth aspect, the memory controller is configured to encode the PIM operation into the command table by inputting, into the command table, a second set of identification bits associated with the PIM operation.

In a fifteenth aspect, in combination with any one of the twelfth aspect through the fourteenth aspect, the operations further include, prior to identifying the memory command in the command table, executing a clock auto synchronization - PIM (CAS-PIM) command in the command table; and determining, based on the CAS-PIM command, a command table ID used for mapping the memory command to the PIM operation.

In a sixteenth aspect, in combination with any one of the twelfth aspect through the fifteenth aspect, the command table further includes a set of register domain IDs (RDIDs). The memory controller is configured to execute the CAS-PIM command by accessing, based on each RDID, a subset of registers for additional data storage.

In a seventeenth aspect, in combination with any one of the twelfth aspect through the sixteenth aspect, the operations further include, prior to executing the PIM operation, executing a non-PIM operation. The non-PIM operation is encoded into the command table using a command table ID that is associated with mapping the PIM operation. Furthermore, the PIM operation is executed using a column address (CA) associated with the execution of the non-PIM operation.

In an eighteenth aspect, in combination with any one of the twelfth aspect through the seventeenth aspect, the memory command is a read short (RD-S) command. The PIM operation mapped to the RD-S command is a read register (RdReg) operation. The memory controller is configured to encode the PIM operation into the command table by: encoding, using a first command table ID of the set of command table IDs, a read accumulate command into the command table; and encoding, using a second command table ID of the set of command table IDs, a read vector command into the command table.

In a nineteenth aspect, in combination with any one of the twelfth aspect through the eighteenth aspect, the memory command is a write short (WR-S) command. The PIM operation mapped to the WR-S command is a write register (WrReg) operation. The memory controller is configured to encode the PIM operation into the command table by: encoding, using a first command table ID of the set of command table IDs, a write vector (WrVec) command into the command table; and encoding, using a second command table ID of the set of command table IDs, a write accumulate (WrAcc) command into the command table.

In a twentieth aspect, in combination with any one of the twelfth aspect through the nineteenth aspect, the memory command is a reserved for use (RFU) command. The PIM operation mapped to the RFU command is a load and execute (LdExe) operation. The memory controller is configured to encode the PIM operation into the command table by: encoding, using a first command table ID of the set of command table IDs, a load scale (LdScale) command into the command table; and encoding, using a second command table ID of the set of command table IDs, a load vector (LdVec) commend into the command table.

In a twenty first aspect, in combination with any one of the twelfth aspect through the twentieth aspect, the memory command is a reserved for use (RFU) command. The PIM operation mapped to the RFU command is a move register (MovReg) operation. The memory controller is configured to encode the PIM operation into the command table by: encoding, using a first command table ID of the set of command table IDs, a load MAC (LdMAC) command into the command table; and encoding, using a second command table ID of the set of command table IDs, a store accumulate (StAcc) command into the command table.

In a twenty second aspect, in combination with any one of the twelfth aspect through the twenty first aspect, the method further includes: identifying an activation function or a precharge function in the command table associated with the memory device; determining that the activation function or the precharge function is directed to multiple memory banks in the memory device based on an identification bit in the command table; and executing the activation function or the precharge function to respectively activate or precharge the multiple banks.

In a twenty third aspect, an apparatus for implementing processing in memory (PIM) operations using a DRAM command table is disclosed. The apparatus includes: a memory including one or more registers and configured to store PIM contexts; and a memory controller coupled to the memory, and configured to perform operations, the operations including: identifying a memory command in the command table associated with the memory device; mapping, based on a set of command table IDs, the memory command to a PIM operation of a plurality of PIM operations; encode the PIM operation into the command table; and executing, by the memory controller, the PIM operation using the command table.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it should be appreciated that throughout this disclosure, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system’s registers and memories into other data similarly represented as physical quantities within the computer system’s registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as, e.g., “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for implementing processing-in-memory (PIM) commands in a command table associated with a memory device, comprising:
identifying, by a memory controller, a memory command in the command table associated with the memory device;
mapping, based on a set of command table IDs, the memory command to a PIM operation of a plurality of PIM operations;
encoding the PIM operation into the command table; and
executing, by the memory controller, the PIM operation using the command table.

2. The method of claim 1, wherein identifying the memory command comprises decoding, from the command table, a first set of identification bits associated with the memory command.

3. The method of claim 1, wherein encoding the PIM operation into the command table comprises inputting, into the command table, a second set of identification bits associated with the PIM operation.

4. The method of claim 1, further comprising, prior to identifying the memory command in the command table,
executing, by the memory controller, a clock auto synchronization - PIM (CAS-PIM) command in the command table; and
determining, based on the CAS-PIM command, a command table ID used for mapping the memory command to the PIM operation.

5. The method of claim 4, wherein the command table further comprises a set of register domain IDs (RDIDs),
wherein executing the CAS-PIM command comprises accessing, based on each RDID, a subset of registers for additional data storage.

6. The method of claim 1, further comprising, prior to executing the PIM operation,
executing a non-PIM operation,
wherein the non-PIM operation is encoded into the command table using a command table ID that is associated with mapping the PIM operation,
wherein the PIM operation is executed using a column address (CA) associated with the execution of the non-PIM operation.

7. The method of claim 1, wherein the memory command is a read short (RD-S) command, wherein the PIM operation mapped to the RD-S command is a read register (RdReg) operation, wherein encoding the PIM operation into the command table comprises:
encoding, using a first command table ID of the set of command table IDs, a read accumulate command into the command table; and
encoding, using a second command table ID of the set of command table IDs, a read vector command into the command table.

8. The method of claim 1, wherein the memory command is a write short (WR-S) command, wherein the PIM operation mapped to the WR-S command is a write register (WrReg) operation, wherein encoding the PIM operation into the command table comprises:
encoding, using a first command table ID of the set of command table IDs, a write vector (WrVec) command into the command table; and
encoding, using a second command table ID of the set of command table IDs, a write accumulate (WrAcc) command into the command table.

9. The method of claim 1, wherein the memory command is a reserved for future use (RFU) command, wherein the PIM command mapped to the RFU command is a load and execute (LdExe) operation, wherein encoding the PIM operation into the command table comprises:
encoding, using a first command table ID of the set of command table IDs, a load scale (LdScale) command into the command table; and
encoding, using a second command table ID of the set of command table IDs, a load vector (LdVec) commend into the command table.

10. The method of claim 1, wherein the memory command is a reserved for future use (RFU) command, wherein the PIM command mapped to the RFU command is a move register (MovReg) operation, wherein encoding the PIM operation into the command table comprises:
encoding, using a first command table ID of the set of command table IDs, a load MAC (LdMAC) command into the command table; and
encoding, using a second command table ID of the set of command table IDs, a store accumulate (StAcc) command into the command table.

11. The method of claim 1, further comprising:
identifying an activation function or a precharge function in the command table associated with the memory device;
determining that the activation function or the precharge function is directed to multiple memory banks in the memory device based on an identification bit in the command table; and
executing the activation function or the precharge function to respectively activate or precharge the multiple memory banks.

12. An apparatus for implementing processing in memory (PIM) operations using a command table, the apparatus comprising:
a memory device comprising one or more registers and configured to store PIM contexts; and
a memory controller coupled to the memory, and configured to perform operations, the operations comprising:
identifying a memory command in the command table associated with the memory device;
mapping, based on a set of command table IDs, the memory command to a PIM operation of a plurality of PIM operations;
encode the PIM operation into the command table; and
executing, by the memory controller, the PIM operation using the command table.

13. The apparatus of claim 12, wherein the memory controller is configured to identify the memory command by decoding, from the command table, a first set of identification bits associated with the memory command.

14. The apparatus of claim 12, wherein the memory controller is configured to encode the PIM operation into the command table by inputting, into the command table, a second set of identification bits associated with the PIM operation.

15. The apparatus of claim 12, wherein the operations further comprise, prior to identifying the memory command in the command table,
executing a clock auto synchronization - PIM (CAS-PIM) command in the command table; and
determining, based on the CAS-PIM command, a command table ID used for mapping the memory command to the PIM operation.

16. The apparatus of claim 15, wherein the command table further comprises a set of register domain IDs (RDIDs),
wherein the memory controller is configured to execute the CAS-PIM command by accessing, based on each RDID, a subset of registers for additional data storage.

17. The apparatus of claim 12, wherein the operations further comprise, prior to executing the PIM operation,
executing a non-PIM operation,
wherein the non-PIM operation is encoded into the command table using a command table ID that is associated with mapping the PIM operation,
wherein the PIM operation is executed using a column address (CA) associated with the execution of the non-PIM operation.

18. The apparatus of claim 12, wherein the memory command is a read short (RD-S) command, wherein the PIM operation mapped to the RD-S command is a read register (RdReg) operation, wherein the memory controller is configured to encode the PIM operation into the command table by:
encoding, using a first command table ID of the set of command table IDs, a read accumulate command into the command table; and
encoding, using a second command table ID of the set of command table IDs, a read vector command into the command table.

19. The apparatus of claim 12, wherein the memory command is a write short (WR-S) command, wherein the PIM operation mapped to the WR-S command is a write register (WrReg) operation, wherein the memory controller is configured to encode the PIM operation into the command table by:
encoding, using a first command table ID of the set of command table IDs, a write vector (WrVec) command into the command table; and
encoding, using a second command table ID of the set of command table IDs, a write accumulate (WrAcc) command into the command table.

20. A system for implementing processing in memory (PIM) operations using a command table, the system comprising:
a plurality of command tables identifiable by a respective plurality of command table IDs, wherein the plurality of command tables includes at least a first command table comprising a memory command, and a second command table comprising a PIM command;
a memory comprising one or more registers and configured to store PIM contexts; and
a memory controller coupled to the memory, and configured to perform operations comprising:
identifying the memory command in the first command table;
mapping, based on a first command table ID identifying the first command table and a second command table ID identifying the second command table, the memory command to the PIM command;
encoding the PIM command into the first command table; and
executing, by the memory controller, the PIM command using the first command table.
